(19) United States
(12) Patent Application Publication
(10) Pub. No.: US 2024/0326433 A1
(43) Pub. Date: Oct. 3, 2024

(54) LIQUID EJECTING HEAD AND LIQUID EJECTING APPARATUS

(71) Applicant: SEIKO EPSON CORPORATION, Tokyo (JP)

(72) Inventors: Hiroyuki HAGIWARA, MATSUMOTO-SHI (JP); Shun KATSUIE, MATSUMOTO-SHI (JP)

(21) Appl. No.: 18/614,859

(22) Filed: Mar. 25, 2024

(30) Foreign Application Priority Data
Mar. 27, 2023 (JP) 2023-050558

(51) Int. Cl. B41J 2/15

(52) U.S. Cl. CPC B41J 2/15; B41J 2202/12

(57) ABSTRACT

There is provided a liquid ejecting head H including a plurality of head chips. The plurality of head chips include one or a plurality of first head chips and one or a plurality of second head chips having a higher ejection ability than the first head chip.

The present application is based on, and claims priority from JP Application Serial Number 2023-050558, filed Mar. 27, 2023, the disclosure of which is hereby incorporated by reference herein in its entirety.

### BACKGROUND

### 1. Technical Field

The present disclosure relates to a liquid ejecting head and a liquid ejecting apparatus that eject a liquid from a nozzle, and particularly, to an ink jet recording head and an ink jet recording apparatus that eject an ink as a liquid.

### 2. Related Art

A liquid ejecting head includes a head chip including a nozzle that ejects a liquid and a pressure generation unit that causes a pressure change in a liquid in a flow path that communicates with the nozzle.

In the head chip, it is difficult to increase the number of nozzle rows or elongate the nozzle row in which the nozzles are arranged side by side in a single unit, because the yield of the head chip decreases and the manufacturing cost increases. Therefore, a liquid ejecting head in which a plurality (two or more) of head chips are fixed to a common member is proposed (for example, see JP-A-2021-133604).

However, since the plurality of head chips constituting the liquid ejecting head have a common structure, the expandability of the liquid ejecting head and the liquid ejecting apparatus is limited, and a liquid ejecting head and a liquid ejecting apparatus with high expandability are desired.

### SUMMARY

According to an aspect of the present disclosure, there is provided a liquid ejecting head including a plurality of head chips that eject a liquid. The plurality of head chips include one or a plurality of first head chips and one or a plurality of second head chips having a higher ejection ability than the first head chip.

According to another aspect of the present disclosure, there is provided a liquid ejecting apparatus including the liquid ejecting head. The liquid ejecting apparatus includes a first line head that includes one or a plurality of the liquid ejecting heads and has the first direction as a longitudinal direction, and a transport unit that transports a medium in a transport direction. The first chip group in the liquid ejecting head of the first line head is disposed on a downstream of the second chip group in the transport direction, the first chip group in the liquid ejecting head of the first line head ejects an ink containing a coloring material, and the second chip group in the liquid ejecting head of the first line head ejects a pre-treatment liquid.

According to still another aspect of the present disclosure, there is provided a liquid ejecting apparatus including the liquid ejecting head described in the above aspect. The liquid ejecting apparatus includes a first liquid ejecting head that is the liquid ejecting head, a second liquid ejecting head that is the liquid ejecting head, and a carriage that holds the first liquid ejecting head and the second liquid ejecting head and reciprocates in a main scanning direction. The first liquid ejecting head and the second liquid ejecting head are arranged in the main scanning direction, the plurality of head chips of the first liquid ejecting head are arranged in the main scanning direction, and the plurality of head chips of the second liquid ejecting head are arranged in the main scanning direction. The one or the plurality of first head chips in the first liquid ejecting head are disposed between the one or the plurality of second head chips in the first liquid ejecting head and the second liquid ejecting head in the main scanning direction. The one or the plurality of first head chips in the second liquid ejecting head are disposed between the one or the plurality of second head chips in the second liquid ejecting head and the first liquid ejecting head in the main scanning direction. The plurality of first head chips in the first liquid ejecting head and the second liquid ejecting head eject an ink containing a coloring material. The second head chip in the second liquid ejecting head ejects a pre-treatment liquid, and the second head chip in the first liquid ejecting head ejects a post-treatment liquid.

According to still yet another aspect of the present disclosure, there is provided a liquid ejecting apparatus including the liquid ejecting head described in the above aspect. The liquid ejecting apparatus includes a first liquid ejecting head that is the liquid ejecting head, a second liquid ejecting head that is the liquid ejecting head, and a carriage that holds the first liquid ejecting head and the second liquid ejecting head and reciprocates in a main scanning direction. In the first liquid ejecting head, the one or the plurality of second head chips are disposed on an upstream of the one or the plurality of first head chips in a transport direction of a medium. In the second liquid ejecting head, the one or the plurality of second head chips are disposed on a downstream of the one or the plurality of first head chips in the transport direction. The first liquid ejecting head and the second liquid ejecting head are disposed such that the one or the plurality of first head chips in the first liquid ejecting head have the same positions as the one or the plurality of first head chips in the second liquid ejecting head in the transport direction. The plurality of first head chips in the first liquid ejecting head and the second liquid ejecting head eject an ink containing a coloring material. The second head chip in the first liquid ejecting head ejects a pre-treatment liquid, and the second head chip in the second liquid ejecting head ejects a post-treatment liquid.

According to still yet another aspect of the present disclosure, there is provided a liquid ejecting apparatus including the liquid ejecting head described in the above aspect. The liquid ejecting apparatus includes a first liquid ejecting head that is the liquid ejecting head, a second liquid ejecting head that is the liquid ejecting head, and a carriage that holds the first liquid ejecting head and the second liquid ejecting head and reciprocates in a main scanning direction. The first liquid ejecting head and the second liquid ejecting head are disposed at the same position in a transport direction of a medium and are arranged in the main scanning direction. The one or the plurality of first head chips in the first liquid ejecting head are located at a first position in the transport direction, and the one or the plurality of second head chips in the first liquid ejecting head are located at a second position different from the first position in the transport direction. The one or the plurality of first head chips in the second liquid ejecting head are located at the second position in the transport direction, and the one or the plurality of second head chips in the second liquid ejecting head are located at the first position in the transport direction. The plurality of first head chips in the first liquid ejecting head and the second liquid ejecting head eject a first liquid, and the plurality of second head chips in the first liquid ejecting head and the second liquid ejecting head eject a second liquid.

### BRIEF DESCRIPTION OF THE DRAWINGS

FIG. 1 is a view illustrating a schematic configuration of a liquid ejecting apparatus according to a first embodiment.

FIG. 2 is an exploded perspective view of a liquid ejecting head according to the first embodiment.

FIG. 3 is a cross-sectional view of a main portion of the liquid ejecting head according to the first embodiment.

FIG. 4 is a schematic view illustrating a configuration of a flow path of the liquid ejecting apparatus according to the first embodiment.

FIG. 5 is an exploded perspective view of a head chip according to the first embodiment.

FIG. 6 is a plan view of a flow path forming substrate according to the first embodiment.

FIG. 7 is a cross-sectional view of the head chip according to the first embodiment.

FIG. 8 is a diagram illustrating a drive signal according to the first embodiment.

FIG. 9 is a schematic view of the liquid ejecting head according to the first embodiment.

FIG. 10 is a schematic view of a liquid ejecting head according to a first modification example of the first embodiment.

FIG. 11 is a schematic view of a liquid ejecting head according to a second modification example of the first embodiment.

FIG. 12 is an exploded perspective view of a liquid ejecting head according to a third modification example of the first embodiment.

FIG. 13 is a plan view of the liquid ejecting head according to the third modification example of the first embodiment.

FIG. 14 is a cross-sectional view of the liquid ejecting head according to the third modification example of the first embodiment.

FIG. 15 is a schematic view of the liquid ejecting head according to the third modification example of the first embodiment.

FIG. 16 is a schematic view of a liquid ejecting head according to a fourth modification example of the first embodiment.

FIG. 17 is a schematic view of a liquid ejecting head according to a fifth modification example of the first embodiment.

FIG. 18 is a schematic view illustrating a configuration of a flow path of a liquid ejecting apparatus according to the fifth modification example of the first embodiment.

FIG. 19 is a schematic view of a liquid ejecting head according to a comparative example of the fifth modification example of the first embodiment.

FIG. 20 is a schematic view of a liquid ejecting head according to a sixth modification example of the first embodiment.

FIG. 21 is a view illustrating a schematic configuration of a liquid ejecting apparatus according to a second embodiment.

FIG. 22 is a schematic view of a head module according to the second embodiment.

FIG. 23 is an exploded perspective view of a liquid ejecting head according to the second embodiment.

FIG. 24 is a schematic view of the liquid ejecting head according to the second embodiment.

FIG. 25 is a cross-sectional view of the liquid ejecting head according to the second embodiment.

### DESCRIPTION OF EMBODIMENTS

Hereinafter, the present disclosure will be described in detail based on embodiments. However, the following description illustrates an aspect of the present disclosure, and can be freely changed within the scope of the present disclosure. Those having the same reference signs in each of the drawings indicate the same members, and the description thereof is omitted as appropriate. In each of the drawings, X, Y, and Z represent three spatial axes orthogonal to each other. In the present specification, directions along these axes are set as an X-direction, a Y-direction, and a Z-direction. A direction where the arrow in each of the drawings is the positive (+) direction, and a direction opposite to the arrow is the negative (−) direction. In addition, the directions of three spatial axes that do not limit the positive direction and the negative direction will be described as the X-axis direction, the Y-axis direction, and the Z-axis direction.

### First Embodiment

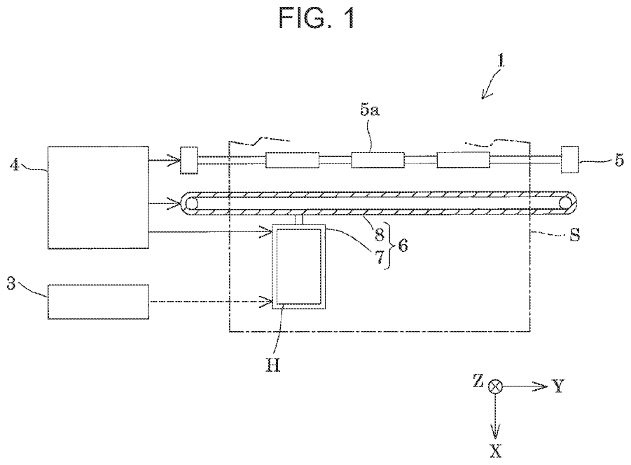

FIG. 1 is a view illustrating a schematic configuration of a liquid ejecting apparatus 1 according to the present disclosure.

The liquid ejecting apparatus 1 illustrated in FIG. 1 includes a liquid ejecting head H. The liquid ejecting apparatus 1 is a so-called serial type printer that performs printing by transporting the medium S in the X-axis direction and ejecting an ink that is one type of “liquid” from the liquid ejecting head H to a medium S in the +Z direction while causing the liquid ejecting head H to reciprocate in the Y-axis direction. As the medium S, any material such as a resin film or cloth can be used in addition to recording paper. A direction in which the liquid ejecting head H reciprocates is not limited to the Y-axis direction, and may be a direction inclined with respect to both the X-axis direction and the Y-axis direction.

Such a liquid ejecting apparatus 1 includes the liquid ejecting head H, a liquid storage section 3, a control unit 4 that is a controller, a transport mechanism 5 that feeds out a medium S, and a moving mechanism 6.

The liquid ejecting head H ejects an ink supplied from the liquid storage section 3 that stores the ink as ink droplets in the +Z direction.

The liquid storage section 3 individually stores a plurality of types, for example, a plurality of colors of ink ejected from the liquid ejecting head H. Examples of the liquid storage section 3 include a cartridge that can be attached to and detached from the liquid ejecting apparatus 1, a bag-shaped ink pack formed of a flexible film, an ink tank that can be refilled with ink, and the like. In addition, for example, a plurality of types of inks having different colors, components, and the like are stored in the liquid storage section 3. Further, the liquid storage section 3 may be divided into a main tank and a sub tank. The sub tank may be coupled to the liquid ejecting head H, and the sub tank is refilled with the ink consumed by ejecting the ink droplets from the liquid ejecting head H from the main tank.

The control unit 4 includes a control device such as a central processing unit (CPU) or a field programmable gate array (FPGA), and a storage device such as a semiconductor memory. The control unit 4 also includes a power supply device that supplies power supplied from an external power supply such as a commercial power supply to each element of the liquid ejecting apparatus 1. The control unit 4 is electrically coupled to the liquid ejecting head H via an external wiring (not illustrated). The control unit 4 totally controls each element of the liquid ejecting apparatus 1, that is, the liquid ejecting head H, the transport mechanism 5, the moving mechanism 6, and the like by executing the program stored in the storage device by the control device.

The transport mechanism 5 transports the medium S in the X-axis direction, and has a transport roller 5a. That is, the transport mechanism 5 transports the medium S in the X-axis direction by rotating the transport roller 5a. The transport roller 5a is rotated by driving a transport motor (not illustrated). The control unit 4 controls the transport of the medium S by controlling the drive of the medium transport motor. The transport mechanism 5 that transports the medium S is not limited to the one including the transport roller 5a, and may transport the medium S by a belt or a drum.

The moving mechanism 6 is a mechanism for reciprocating the liquid ejecting head H in the Y-axis direction, and includes a support member 7 and a transport belt 8. The support member 7 is a so-called carriage that supports the liquid ejecting head H, and is fixed to the transport belt 8. The transport belt 8 is an endless belt erected along the Y-axis direction. The transport belt 8 is rotated by driving a transport motor (not illustrated). The control unit 4 rotates the transport belt 8 by controlling the drive of the transport motor to reciprocate the liquid ejecting head H together with the support member 7 in the Y-axis direction. The support member 7 may be configured to mount the liquid storage section 3 together with the liquid ejecting head H.

Under the control of the control unit 4, the liquid ejecting head H performs an ejection operation of ejecting the ink supplied from the liquid storage section 3 in the +Z direction as ink droplets from each of a plurality of nozzles 21. The ejection operation by the liquid ejecting head H is performed in parallel with the transporting of the medium S by the transport mechanism 5 and the reciprocating movement of the liquid ejecting head H by the moving mechanism 6, so that so-called printing is performed in which an image is formed at the surface of the medium S using ink.

In the present embodiment, the Y-axis direction is an example of a “main scanning direction”, and the X-axis direction is an example of a “sub-scanning direction” or a “transport direction”.

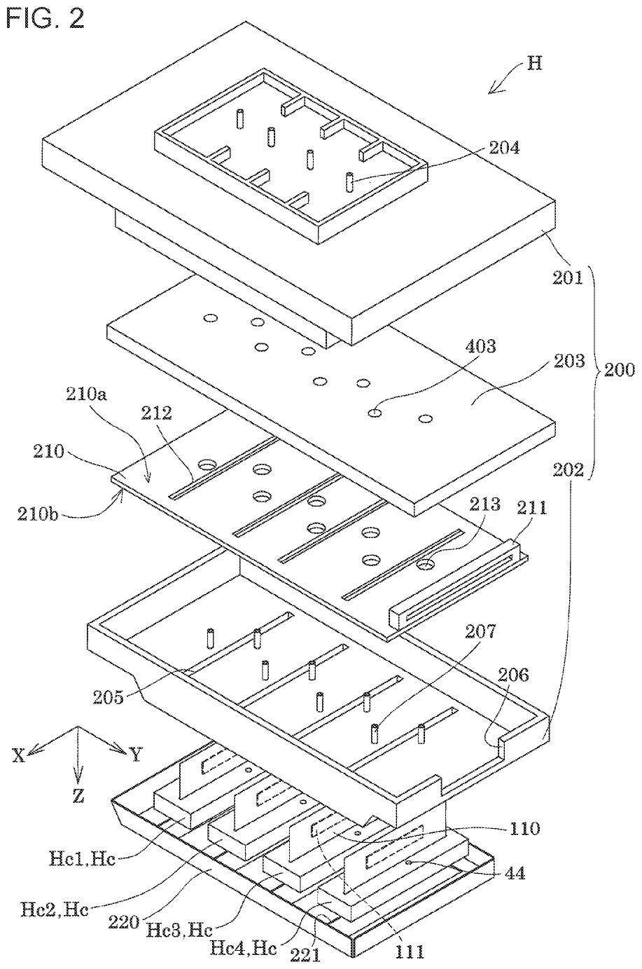

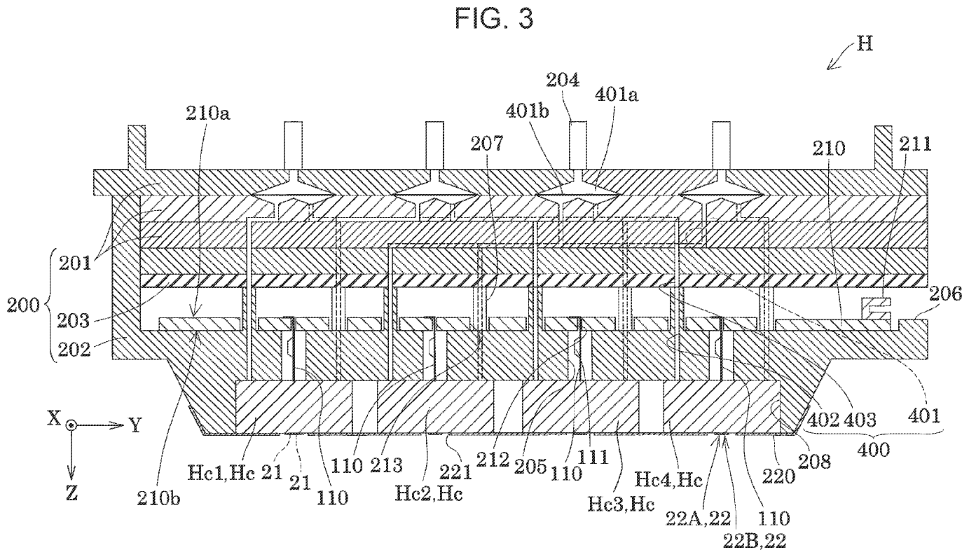

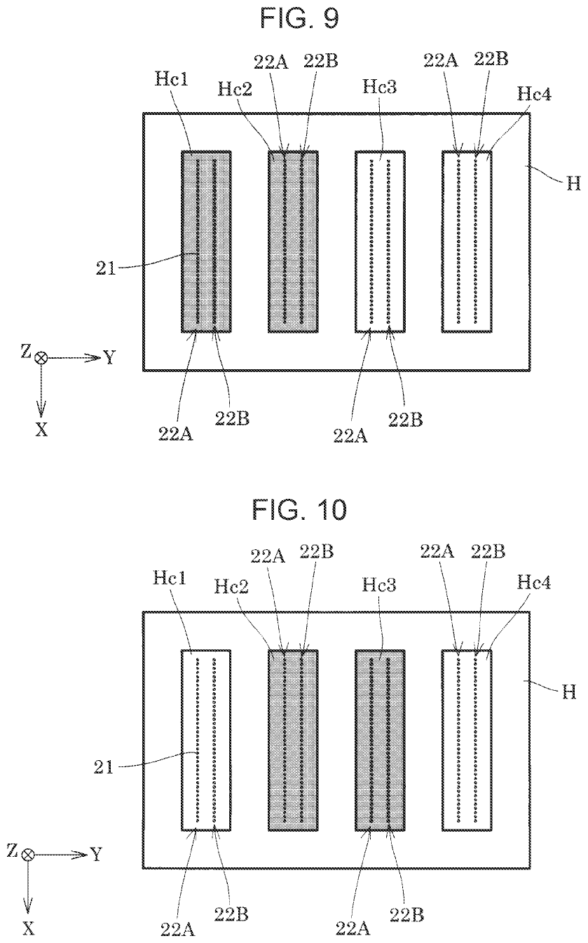

FIG. 2 is an exploded perspective view of the liquid ejecting head H in the present embodiment. FIG. 3 is a cross-sectional view of the main portion of the liquid ejecting head H. FIG. 9 is a schematic view of the liquid ejecting head H when viewed in the +Z direction. Each direction of the liquid ejecting head H will be described based on the directions when mounted on the liquid ejecting apparatus 1, that is, the X-axis direction, the Y-axis direction, and the Z-axis direction.

As illustrated in FIGS. 2, 3, and 9, the liquid ejecting head H includes a plurality of head chips Hc, a flow path member 200 having a flow path 400, a relay substrate 210, and a cover head 220.

The flow path member 200 includes a first flow path member 201 provided with a first flow path 401, a second flow path member 202 provided with a second flow path 402, and a sealing member 203 that couples the first flow path 401 and the second flow path 402 to each other in a liquid-tight state. The first flow path member 201, the sealing member 203, and the second flow path member 202 are stacked in the +Z direction in this order.

In the present embodiment, the first flow path member 201 is configured by stacking three members in the Z-axis direction. The first flow path member 201 includes a coupling portion 204 coupled to the liquid storage section 3 in which an ink that is a liquid is stored. In the present embodiment, the coupling portion 204 is provided to protrude in a tubular shape in the −Z direction from the surface of the first flow path member 201 in the −Z direction. The liquid storage section 3 may be directly coupled to the coupling portion 204 or may be coupled via a supply pipe or the like such as a tube. The first flow path 401 to which the ink from the liquid storage section 3 is supplied is provided inside the coupling portion 204. The first flow path 401 includes a flow path extending in the Z-axis direction, a flow path extending along a stacking interface of the stacked members, and the like. In addition, a widened liquid reservoir 401a having an inner diameter wider than other regions is provided in the middle of the first flow path 401. A filter 401b that captures foreign matters such as dust and air bubbles contained in the ink is provided in the liquid reservoir 401a. In addition, in the present embodiment, one first flow path member 201 includes four coupling portions 204 and four independent first flow paths 401. Each first flow path 401 is branched into two paths on the downstream of the liquid reservoir 401a.

The second flow path member 202 includes a second flow path 402 communicating with each of branched end portions of the first flow path 401 on the opposite side of the coupling portion 204. In other words, eight second flow paths 402 are provided in the present embodiment. The first flow path 401 and the second flow path 402 are liquid-tightly coupled to each other via the sealing member 203. For the sealing member 203, a material which has liquid resistance to liquids such as ink used in the liquid ejecting head H and is elastically deformable, for example, a rubber, elastomer or the like may be used. Such a sealing member 203 is provided with a coupling flow path 403 penetrating in the Z-axis direction. The first flow path 401 and the second flow path 402 communicate with each other via the coupling flow path 403. That is, the flow path 400 of the flow path member 200 includes the first flow path 401, the second flow path 402, and the coupling flow path 403.

The plurality of head chips Hc are held on the surface of the second flow path member 202 facing the +Z direction. Specifically, the second flow path member 202 includes an accommodation portion 208 having a recessed shape that opens on the surface facing the +Z direction, and the head chip Hc is accommodated in the accommodation portion 208. The liquid ejecting head H in the present embodiment holds a plurality of head chips, and in the present embodiment, the liquid ejecting head H holds four head chips Hc as an example. In the present embodiment, the four head chips Hc are arranged side by side in the Y-axis direction to be located at the same position in the X-axis direction. In the present embodiment, the four head chips Hc arranged side by side in the Y-axis direction are sequentially referred to as a head chip Hc1, a head chip Hc2, a head chip Hc3, and a head chip Hc4 in the +Y direction. When the head chips Hc1 to Hc4 are not distinguished from each other, the head chips Hc1 to Hc4 are referred to as the head chip Hc below.

In the present embodiment, a configuration in which one accommodation portion 208 is provided in common to all the head chips Hc is described, but the configuration is not particularly limited thereto. For example, the accommodation portion 208 may be provided independently for each head chip Hc, or may be independently provided for each group of a plurality (two or more) of head chips Hc.

The second flow path 402 communicates with each inlet 44 of such a head chip Hc.

In addition, the second flow path member 202 is provided with a wiring insertion hole 205 for inserting a wiring member 110 of each head chip Hc. In the present embodiment, one wiring insertion hole 205 is provided for each head chip Hc. That is, in the present embodiment, eight wiring insertion holes 205 in total are provided for the eight head chips Hc. The wiring member 110 of the head chip Hc is flowed out to the surface side of the second flow path member 202 facing the −Z direction via the wiring insertion hole 205.

In the Z-axis direction, the relay substrate 210 to which the wiring members 110 of the plurality of head chips Hc are commonly coupled is provided between the second flow path member 202 and the sealing member 203. The relay substrate 210 is formed of a hard rigid substrate with no flexibility. Wirings, electronic components, and the like (not illustrated) are mounted on the relay substrate 210. In the present embodiment, as an electronic component, a connector 211 to which an external wiring (not illustrated) provided outside the liquid ejecting head H is coupled is illustrated. A printing signal for controlling the head chip Hc is input to the relay substrate 210 from the external wiring via the connector 211, and is supplied from the relay substrate 210 to each head chip Hc. An external wiring opening portion 206 for inserting an external wiring coupled to the connector 211 is provided on the side wall of the flow path member 200, that faces the connector 211. The external wiring is coupled to the connector 211 of the relay substrate 210, which is provided inside the flow path member 200, via the external wiring opening portion 206.

The relay substrate 210 is provided with a wiring insertion hole 212 for flowing out the wiring member 110 of the head chip Hc to the surface side facing the −Z direction. One wiring insertion hole 212 is provided for each head chip Hc, and four wiring insertion holes 212 in total are provided.

In addition, the relay substrate 210 is provided with a protrusion portion insertion hole 213 provided to penetrate the relay substrate 210 in the Z-axis direction. A protrusion portion 207 in which the second flow path 402 is provided is provided on the surface of the second flow path member 202 facing the −Z direction to protrude in the −Z direction. The protrusion portion 207 is inserted in the −Z direction side of the relay substrate 210 via the protrusion portion insertion hole 213, and thus is coupled to the coupling flow path 403.

The cover head 220 is fixed to the surface of the flow path member 200 facing the +Z direction. The cover head 220 defines a space of the accommodation portion 208 that accommodates the head chip Hc. In the present embodiment, the cover head 220 has a size enough for covering four head chips Hc. The cover head 220 is provided with an exposure opening portion 221 that exposes a nozzle 21 of the head chip Hc in the +Z direction independently for each head chip Hc. An ink is ejected from the nozzle 21 exposed from the exposure opening portion 221 in the +Z direction.

The accommodation portion 208 in the present embodiment corresponds to an “accommodation space” that accommodates the head chip Hc.

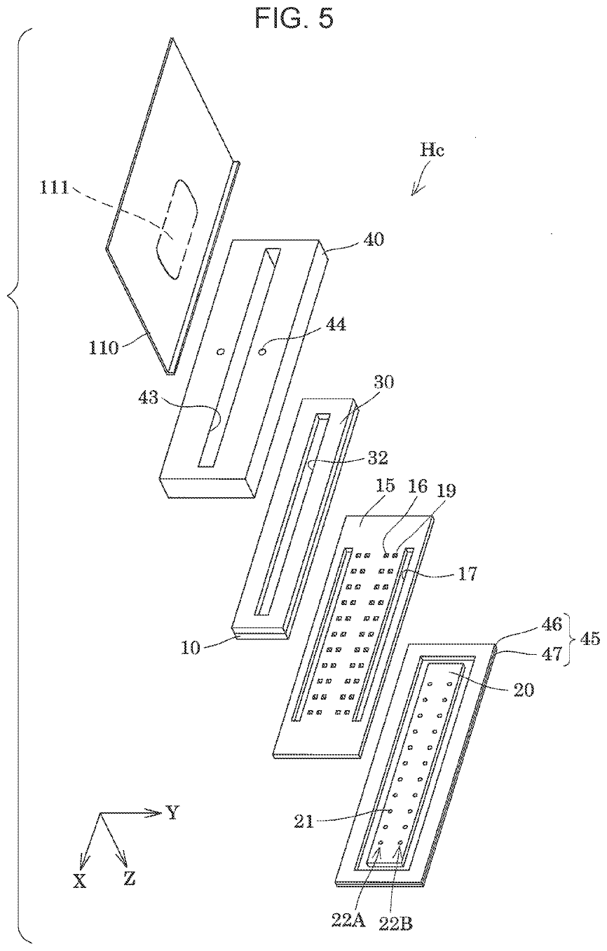

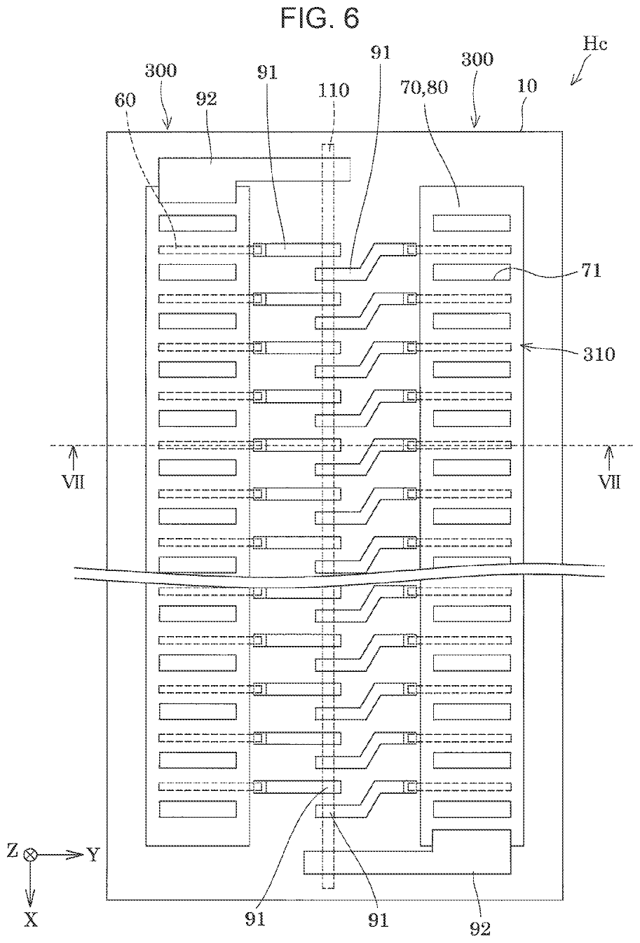

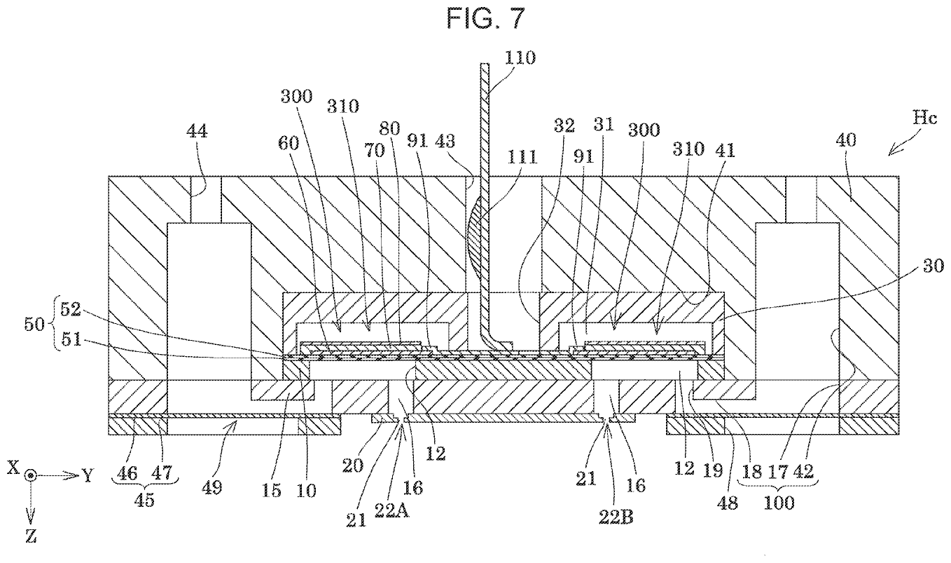

Here, an example of the head chip Hc will be described with reference to FIGS. 5 to 7. FIG. 5 is an exploded perspective view of the head chip Hc in the present embodiment. FIG. 6 is a plan view of a flow path forming substrate 10 when viewed in the +Z direction. FIG. 7 is a cross-sectional view of the head chip Hc taken along line VII-VII in FIG. 6. Each direction of the head chip Hc will be described based on the directions when mounted on the liquid ejecting head H, that is, the X-axis direction, the Y-axis direction, and the Z-axis direction.

As illustrated in FIGS. 5 to 7, the head chip Hc in the present embodiment includes one nozzle plate 20 in which a plurality of nozzles 21 are formed, the flow path forming substrate 10, a communication plate 15, a protective substrate 30, a case member 40, a piezoelectric actuator 300, and the wiring member 110.

The flow path forming substrate 10 is made of, for example, a silicon substrate, a glass substrate, an SOI substrate, or various ceramic substrates. On the flow path forming substrate 10, a plurality of pressure chambers 12 are disposed side by side along the X-axis direction. The plurality of pressure chambers 12 are disposed on a straight line along the X-axis direction such that positions in the Y-axis direction are the same. The two pressure chambers 12 adjacent to each other in the X-axis direction are partitioned by partition walls which are not illustrated. In addition, in the present embodiment, two rows of pressure chambers 12 in which the pressure chambers 12 are arranged side by side in the X-axis direction are provided in the Y-axis direction. The disposition of the pressure chambers 12 is not particularly limited thereto. For example, the plurality of pressure chambers 12 may be disposed along the X-axis direction in a staggered manner.

The communication plate 15 and the nozzle plate 20 are sequentially stacked on the surface of the flow path forming substrate 10 facing the +Z direction. A diaphragm 50 and the piezoelectric actuator 300 are sequentially stacked on the surface of the flow path forming substrate 10 facing the −Z direction.

The communication plate 15 is formed of a plate-shaped member bonded to the surface of the flow path forming substrate 10 facing the +Z direction. The communication plate 15 is provided with a nozzle communication passage 16 through which the pressure chamber 12 and the nozzle 21 communicate with each other. The communication plate 15 is provided with a first manifold portion 17 and a second manifold portion 18 that form a portion of a manifold 100 serving as a common liquid chamber with which the plurality of pressure chambers 12 commonly communicate. The first manifold portion 17 is provided to penetrate the communication plate 15 in the Z-axis direction. Further, the second manifold portion 18 is provided to open on the surface on the side facing the +Z direction without penetrating the communication plate 15 in the Z-axis direction. The communication plate 15 is provided with a supply communication passage 19 that communicates with one end portion of the pressure chamber 12 in the Y-axis direction, independently for each pressure chamber 12. The supply communication passage 19 communicates between the second manifold portion 18 and the pressure chambers 12 to supply the ink in the manifold 100 to the pressure chambers 12. As such a communication plate 15, a silicon substrate, a glass substrate, an SOI substrate, various ceramic substrates, a metal substrate such as a stainless steel substrate, or the like can be used.

The nozzle plate 20 is bonded to the side of the communication plate 15 opposite to the flow path forming substrate 10, that is, to the surface facing the +Z direction. A plurality of nozzles 21 communicating with the respective pressure chambers 12 via nozzle communication passages 16 are formed in the nozzle plate 20. In the present embodiment, the plurality of nozzles 21 are disposed to be arranged in a row along the X-axis direction. In the present embodiment, two nozzle rows, in which the nozzles 21 are arranged side by side along the X-axis direction, are provided at a distance in the Y-axis direction. As such a nozzle plate 20, a silicon substrate, a glass substrate, an SOI substrate, various ceramic substrates, a metal substrate such as a stainless steel substrate, an organic substance such as a polyimide resin, or the like can be used.

In the present embodiment, the diaphragm 50 includes an elastic film 51 that is provided on the flow path forming substrate 10 side and is formed of silicon oxide, and an insulator film 52 that is provided on the surface of the elastic film 51 facing the −Z direction and is formed of zirconium oxide. The diaphragm 50 may be formed of only the elastic film 51 or only the insulator film 52, and may have a configuration in which other films are provided in addition to the elastic film 51 and the insulator film 52.

The piezoelectric actuator 300 includes a first electrode 60, a piezoelectric layer 70, and a second electrode 80 that are sequentially stacked on the diaphragm 50 in the −Z direction. Such a piezoelectric actuator 300 is also referred to as a piezoelectric element, and refers to a portion including the first electrode 60, the piezoelectric layer 70, and the second electrode 80. In addition, a portion where piezoelectric strain occurs in the piezoelectric layer 70 when a voltage is applied between the first electrode 60 and the second electrode 80 is referred to as an active portion 310. On the other hand, a portion where piezoelectric strain does not occur in the piezoelectric layer 70 is referred to as an inactive portion. That is, the active portion 310 refers to a portion where the piezoelectric layer 70 is interposed between the first electrode 60 and the second electrode 80. In the present embodiment, the active portion 310 is formed for each pressure chamber 12. That is, a plurality of active portions 310 are formed at the piezoelectric actuator 300. The plurality of active portions 310 serve as “driving elements” that cause pressure changes in the ink inside the pressure chamber 12. In general, any one of the electrodes of the active portion 310 is configured as an independent individual electrode for each active portion 310, and the other electrode is configured as a common electrode common to the plurality of active portions 310. In the present embodiment, the first electrode 60 is configured as an individual electrode, and the second electrode 80 is configured as a common electrode. The first electrode 60 may form a common electrode, and the second electrode 80 may form an individual electrode.

Here, as illustrated in FIGS. 6 and 7, the first electrode 60 forms an individual electrode that is separated for each pressure chamber 12 and is independent for each active portion 310. As illustrated in FIGS. 6 and 7, the piezoelectric layer 70 is continuously provided over the X-axis direction with a predetermined width in the Y-axis direction. As illustrated in FIG. 6, the piezoelectric layer 70 is formed with a plurality of recess portions 71 at positions that do not overlap the first electrode 60. The recess portions 71 may not be provided. Such a piezoelectric layer 70 is configured, for example, by using a piezoelectric material made of a perovskite structure composite oxide represented by the general formula ABO₃. As illustrated in FIGS. 6 and 7, the second electrode 80 is continuously provided on the −Z direction side opposite to the first electrode 60 of the piezoelectric layer 70, and constitutes a common electrode common to the plurality of active portions 310. The second electrode 80 is continuously provided in the X-axis direction so that the Y-axis direction has a predetermined width.

In addition, an individual lead electrode 91, which is a lead-out wiring, is drawn out from the first electrode 60. A common lead electrode 92, which is a lead-out wiring, is drawn out from the second electrode 80. The wiring member 110 formed of a flexible substrate having flexibility is coupled to the end portions of the individual lead electrode 91 and the common lead electrode 92 opposite to the end portions thereof coupled to the piezoelectric actuator 300. A drive signal selection circuit 111 is mounted on the wiring member 110. The drive signal selection circuit 111 has a plurality of switching elements for selecting whether or not to supply a drive signal COM for driving each active portion 310 to each active portion 310. That is, the wiring member 110 in the present embodiment is a chip-on-film (COF). The drive signal selection circuit 111 may not be provided in the wiring member 110. That is, the wiring member 110 may be a flexible flat cable (FFC), a flexible printed circuits (FPC), and the like.

As illustrated in FIGS. 5 and 7, the protective substrate 30 having approximately the same size as the flow path forming substrate 10 is bonded to the surface of the flow path forming substrate 10 facing the −Z direction. The protective substrate 30 includes an accommodation portion 31 which is a space for protecting the piezoelectric actuator 300. The accommodation portion 31 is independently provided for each row of the piezoelectric actuators 300 arranged in the X-axis direction. Two accommodation portions 31 are formed to be arranged in the Y-axis direction. A through-hole 32 penetrating in the Z-axis direction is provided between the two accommodation portions 31 disposed to be arranged in the Y-axis direction, in the protective substrate 30. The end portions of the individual lead electrode 91 and the common lead electrode 92 drawn from the electrodes of the piezoelectric actuator 300 are extended to be exposed in the through-hole 32. The individual lead electrode 91 and the common lead electrode 92 are electrically coupled to the wiring member 110 in the through-hole 32. As such a protective substrate 30, for example, a substrate made of a silicon substrate, a glass substrate, an SOI substrate, and various ceramic substrates is used similarly to the flow path forming substrate 10.

As illustrated in FIG. 7, the case member 40 is fixed on the protective substrate 30 to define, together with the flow path forming substrate 10, the manifold 100 communicating with the plurality of pressure chambers 12. The case member 40 has substantially the same shape as the communication plate 15 described above in plan view, and is bonded to the protective substrate 30 and also bonded to the communication plate 15 described above. Such a case member 40 has a recess portion 41 having a depth for accommodating the flow path forming substrate 10 and the protective substrate 30 on the protective substrate 30 side. The case member 40 is provided with a third manifold portion 42 communicating with the first manifold portion 17 of the communication plate 15. The first manifold portion 17 and the second manifold portion 18 provided in the communication plate 15 and the third manifold portion 42 provided in the case member 40 configure the manifold 100 of the present embodiment. The manifold 100 is provided for each row of the pressure chambers 12, that is, two manifolds 100 in total are provided. Each manifold 100 is continuously provided in the X-axis direction in which the pressure chambers 12 are arranged side by side, and the supply communication passages 19 that communicate each of the pressure chambers 12 and the manifold 100 are arranged side by side in the X-axis direction. The case member 40 is provided with an inlet 44 that communicates with the manifolds 100 to supply an ink to each of the manifolds 100. In addition, the case member 40 is provided with a coupling port 43 through which the wiring member 110 is inserted to communicate with the through-hole 32 of the protective substrate 30. The wiring member 110 is flowed out to the surface side of the liquid ejecting head H facing the −Z direction, via the coupling port 43. As the case member 40, a metal material, a resin material, or the like can be used.

A compliance substrate 45 is provided on the surface of the communication plate 15 on the +Z direction side where the first manifold portion 17 and the second manifold portion 18 are open. The compliance substrate 45 seals the openings of the first manifold portion 17 and the second manifold portion 18 on the +Z direction side. Such a compliance substrate 45 includes a sealing film 46 made of a flexible thin film and a fixation substrate 47 made of a hard material such as metal in the present embodiment. Since a region of the fixation substrate 47 facing the manifold 100 is an opening 48 that is completely removed in the thickness direction, one surface of the manifold 100 is a compliance portion 49 which is a flexible portion sealed only by the flexible sealing film 46. The head chip Hc is fixed to the cover head 220 by fixing the surface of the fixation substrate 47 facing the +Z direction to the surface of the cover head 220 facing the −Z direction.

In such a head chip Hc, an ink is taken in from the inlet 44, and the inside of the flow path from the manifold 100 to the nozzle 21 is filled with the ink. Thereafter, a voltage is applied to each active portion 310 corresponding to the pressure chamber 12 in accordance with a signal from the drive signal selection circuit 111, and thus the diaphragm 50 is flexurally deformed along with the piezoelectric actuator 300. Thus, pressure of the ink in the pressure chamber 12 increases, and ink droplets are ejected from a predetermined nozzle 21.

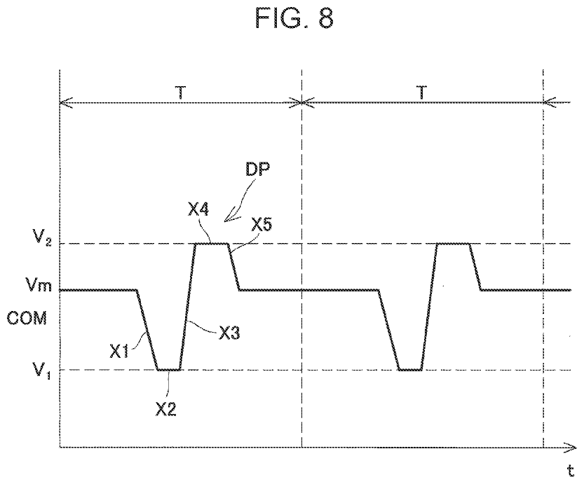

The drive signal COM that is generated by the control unit 4 for ejecting ink droplets from such a head chip Hc will be described with reference to FIG. 8. FIG. 8 is a diagram illustrating the drive signal COM.

As illustrated in FIG. 8, the drive signal COM is repeatedly generated for each unit cycle T defined by a clock signal. The unit cycle T is an ejection cycle T (also referred to as a discharge cycle T) and is also referred to as a recording cycle T. The unit cycle T corresponds to one pixel of an image or the like to be printed on the medium S. In the present embodiment, a drive waveform DP is generated in the unit cycle T.

When a dot pattern for one line (one raster) is formed in the recording region of the medium S during printing, the drive waveform DP is selectively supplied to the active portion 310 corresponding to each nozzle 21 under the control of the drive signal selection circuit 111. In the present embodiment, the drive signal COM is supplied to the first electrode 60 that is an individual electrode by using the second electrode 80 that is a common electrode for the plurality of active portions 310 as a reference potential (vbs). That is, the voltage applied to the first electrode 60 by the drive signal COM is represented as a potential with the reference potential (vbs) as a reference.

Specifically, the drive waveform DP includes a first expansion element X1 and a first expansion maintaining element X2. The first expansion element X1 expands the volume of the pressure chamber 12 from a reference volume by applying a voltage to a first potential V₁ from a state where an intermediate potential Vm is applied. The first expansion maintaining element X2 maintains the volume of the pressure chamber 12 expanded by the first expansion element X1 for a predetermined period. The drive waveform DP further includes a first contraction element X3, a first contraction maintaining element X4, and a first expansion restoring element X5, after the first expansion maintaining element X2. The first contraction element X3 contracts the volume of the pressure chamber 12 by applying a voltage from the first potential V₁ to a second potential V₂. The first contraction maintaining element X4 maintains the volume of the pressure chamber 12 contracted by the first contraction element X3 for a predetermined period. The first expansion restoring element X5 restores the pressure chamber 12 from the contraction state at the second potential V₂ to the reference volume at the intermediate potential Vm.

When such a drive waveform DP is supplied to the active portion 310, the piezoelectric actuator 300 deforms by the first expansion element X1 in a direction in which the volume of the pressure chamber 12 is expanded. Thus, the meniscus in the nozzle 21 is drawn to the pressure chamber 12 side, and the ink is supplied from the manifold 100 side to the pressure chamber 12. Further, the expanded state of the pressure chamber 12 is maintained by the first expansion maintaining element X2. Thereafter, the first contraction element X3 is supplied, and the pressure chamber 12 is rapidly contracted from the expansion volume to the contraction volume corresponding to the second potential V₂. Then, the ink in the pressure chamber 12 is pressurized, and ink droplets are ejected from the nozzle 21. The contraction state of the pressure chamber 12 is maintained by the first contraction maintaining element X4, and the ink pressure in the pressure chamber 12 reduced by the ejection of the ink droplets during this period rises again due to the natural vibration. The first expansion restoring element X5 is supplied in accordance with this rising timing, and thus the pressure chamber 12 is restored to the reference volume, and the pressure fluctuation in the pressure chamber 12 is absorbed.

In the present embodiment, it is assumed that the drive signal COM has one drive waveform DP in one unit cycle T, but the present embodiment is not particularly limited thereto. The drive signal COM may have a plurality (two or more) of drive waveforms DP in one unit cycle T. Further, when the drive signal COM has a plurality of the drive waveforms DP in one unit cycle T, the drive waveforms DP having the same waveform shape may be used, and the drive waveforms DP having different waveform shapes, that is, the drive waveforms DP for which ink droplets to be ejected have different weights may be used, or a mixture thereof may be used. When the drive signal COM has a plurality of drive waveforms DP within one unit cycle T, one pixel (also referred to as one dot) is formed at the medium S by one or a plurality of ink droplets ejected from the nozzle 21 during one unit cycle T, by selecting any one or a plurality of the drive waveforms DP and driving the active portion 310.

Here, the head chips Hc1 to Hc4 are compatible with each other.

Here, the phase of “being compatible” means that, even when one head chip Hc and another head chip Hc are replaced with each other, both the head chips Hc function to eject a liquid. For example, the phrase that one head chip Hc is compatible with another head chip Hc includes a case where the other head chip Hc can be accommodated in an accommodation space in which the one head chip Hc is accommodated, and the one head chip can be accommodated in an accommodation space in which the other head chip Hc is accommodated. The accommodation space is a space between the accommodation portion 208 of the flow path member 200 and the cover head 220. In the present embodiment, the accommodation space is continuously provided in the four head chips Hc, and the same applies to accommodation spaces in which the head chips Hc are individually accommodated. Further, the phrase that two head chips Hc are compatible with each other means that the outer dimensions of the two head chips Hc may not completely coincide with each other as long as the two head chips Hc can be accommodated in the accommodation spaces.

In addition, the phrase that two head chips Hc are compatible with each other includes a case where the numbers of nozzles 21 in the two head chips Hc are equal to each other, the numbers of nozzle rows 22 in the two head chips Hc are equal to each other, the pitches and the like between the nozzles 21 in the two head chips Hc are equal to each other.

The phrase that one head chip Hc is compatible with another head chip Hc includes a case where the coupling portions of the flow paths in the head chips Hc are the same as each other. That is, the phrase includes a case where the positions and the numbers of inlets 44 in the above-described head chips Hc are equal, a coupling method of the flow path, for example, adhesion with an adhesive, coupling by a sealing member such as rubber, and the like are the same. Further, the phrase that one head chip Hc is compatible with another head chip Hc includes a case where electrical coupling portions are the same as each other. That is, the above phrase includes a case where, in the above-described head chip Hc, the lengths of the wiring members 110 are equal to each other, the numbers of terminals coupled to the relay substrate 210 are equal to each other, the lengths of the terminals in the direction in which the terminals are arranged side by side are equal to each other, the sizes of the terminals are equal to each other, the pitches between the terminals are equal to each other, the arrangement orders of the terminals are the same as each other, and the like.

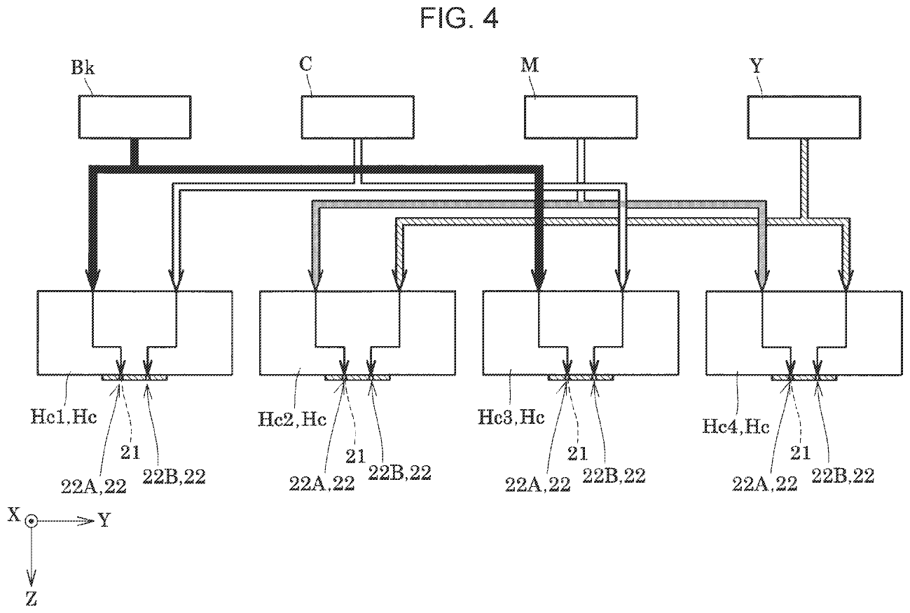

In the present embodiment, as illustrated in FIG. 4, the same ink is supplied to the flow paths communicating with the respective nozzle rows 22A of the head chips Hc1 and Hc3. Further, the same ink is supplied to the flow paths communicating with the respective nozzle rows 22B of the head chips Hc1 and Hc3. In addition, the same ink is supplied to the flow paths communicating with the respective nozzle rows 22A of the head chips Hc2 and Hc4, and the same ink is supplied to the flow paths communicating with the respective nozzle rows 22B of the head chips Hc2 and Hc4. The four types of inks are inks containing coloring materials, for example, four colors of inks of a black ink (Bk), a magenta ink (M), a cyan ink (C), and a yellow ink (Y). That is, the four colors of inks can be ejected from the four respective nozzle rows 22 of the head chips Hc1 and Hc2, and the four colors of inks can be ejected from the four respective nozzle rows 22 of the head chips Hc3 and Hc4. Therefore, color printing with four colors of inks can be performed only by the head chips Hc1 and Hc2, and color printing with four colors of inks can be performed only by the head chips Hc3 and Hc4. FIG. 4 is a schematic view illustrating a configuration of the flow path of the liquid ejecting apparatus 1.

As illustrated in FIG. 9, among such four head chips of the liquid ejecting head H, the ejection abilities of the head chips Hc3 and Hc4 are higher than the ejection abilities of the head chips Hc1 and Hc2.

Here, the “ejection ability” of the head chip Hc means the maximum ejection weight when one dot is formed for one pixel by one nozzle 21. In addition, “forming one dot” refers to the total weight when one pixel is formed at the medium S in the ejection cycle T in the drive waveform DP. For example, there are a case where one dot is formed by one droplet in the ejection cycle T, a case where one dot is formed by a plurality (two or more) of droplets in the ejection cycle T, and the like. A plurality of droplets forming one dot include a droplet obtained by coalescing droplets during flight. Since the head chip Hc has the plurality of nozzles 21, the average value of the ejection abilities of the plurality of nozzles 21 may be used to define the “ejection ability”. The “maximum ejection weight” means an ink weight when the maximum one dot is formed in one ejection cycle T in a drive waveform optimized based on the natural vibration cycle Tc of the pressure chamber 12 in the head chip Hc, the power of the piezoelectric actuator 300, the structure of the nozzle 21 such as the inner diameter. Therefore, the drive waveform for ejecting the maximum ejection weight of the head chips Hc1 and Hc2 and the drive waveform for ejecting the maximum ejection weight of the head chips Hc3 and Hc4 may be the same or different. For example, preferably, a potential difference between the first potential V₁ and the second potential V₂, the inclination of the first contraction element X3, and the like in the above-described drive signal COM are made to vary depending on the head chip Hc having a high ejection ability and the head chip Hc having a low ejection ability.

Further, the “ejection ability” of the head chip Hc can also be defined by the ejection weight of droplets ejected from the nozzles 21 in one ejection cycle T when the same drive waveform DP is input.

The ejection weight refers to the total weight of the droplets ejected from the plurality of nozzles 21. The definition of the “ejection ability” in the present specification is similarly applied in the following description.

In addition, the phrase that “the ejection ability of the second head chip is higher than the ejection ability of the first head chip” means that, in any one of the above definitions, the ejection weight of the “second head chip” is more than the ejection weight of the “first head chip” by 110% or more. That is, the ejection weight W1 of the “first head chip” and the ejection weight W2 of the “second head chip” satisfy W2>W1×1.1.

The ejection weight can be calculated by ejecting ink droplets from a plurality of nozzles 21 in each head chip Hc to a tray, measuring the total weight of the ink droplets ejected to the tray, and dividing the measurement result by the number of nozzles. When the ink droplets are ejected in 2 or more ejection cycles T, the measured total weight may also be divided by the number of ejection cycles in which ejection is performed.

The ejection weight may be obtained by capturing an image of ink droplets during flight with a CCD camera or the like and calculating the weight from the droplet size. Further, the ejection weight may be calculated by measuring the size of dots formed at the medium S.

The ejection cycle T is adjusted in accordance with the moving speed of the liquid ejecting head H in the main scanning direction in the case of the serial type and is adjusted in accordance with the transport speed of the medium S in the case of the line type. Thus, the ejection cycle T is not different between the “first head chip” and the “second head chip”. That is, the ejection cycles T of the “first head chip” and the “second head chip” have the same value optimized in accordance with the moving speed of the liquid ejecting head H in the main scanning direction or the transport speed of the medium S.

Such an ejection ability changes by changing an element that changes the ejection weight when the same drive waveform DP is applied to each head chip Hc, for example, a flow path shape such as the inner diameter of the nozzle 21, and the like. For example, the larger the inner diameter of the nozzle 21, the larger the ejection weight and the higher the ejection ability, and the smaller the inner diameter of the nozzle 21, the smaller the ejection weight and the lower the ejection ability. Further, the higher the ejection ability, the easier it is to perform so-called solid printing, in which a relatively wide area is covered with the liquid, and thus it is possible to improve the productivity. In addition, as the ejection ability becomes smaller, it is possible to print an image with the higher definition.

Further, the ejection weight changes by a difference in the amount of displacement of the piezoelectric actuator 300. Here, the amount of displacement of the piezoelectric actuator 300 refers to an amount of displacement when the piezoelectric actuator 300 is driven at the same voltage. When the amount of displacement becomes larger, the ejection weight when the droplets are ejected from the nozzles 21 increases. In addition, when the amount of displacement becomes smaller, the ejection weight decreases. Therefore, the head chip Hc having the piezoelectric actuator 300 having a small amount of displacement may be used as the “first head chip”, and the head chip Hc having the piezoelectric actuator 300 having a large amount of displacement may be used as the “second head chip”. The amount of displacement of the piezoelectric actuator 300 changes by the structure such as the composition and thickness of each layer constituting the piezoelectric actuator 300 and the diaphragm 50.

The head chip Hc1 and the head chip Hc2 have substantially the same ejection ability, and the head chip Hc3 and the head chip Hc4 have substantially the same ejection ability. The phrase that the ejection abilities of the two head chips Hc are substantially the same as each other means that the difference in the ejection weight ejected from the two head chips Hc is smaller than 10%. That is, the ejection weight W1 of ink droplets ejected from one head chip Hc and the ejection weight W2 of ink droplets ejected from the other head chip Hc satisfy W1×0.9<W2<W1×1.1. Preferably, the ejection weight of the two head chips Hc having substantially the same ejection ability is the same as much as possible, that is, the difference in the ejection weight is close to zero. Therefore, the difference in the ejection weight is preferably within 5%, that is, W1×0.95≤W2≤W1×1.05 is preferably satisfied, and more preferably, the difference in the ejection weight is within 1%, that is, W1×0.99≤W2≤W1×1.01 is satisfied. The definition of “the ejection ability is substantially the same” in the present specification is similarly applied in the following description.

By printing an image with the head chips Hc3 and Hc4 having a high ejection ability, it is possible to fill a wide area in a short time, and thus, it is possible to perform printing in a relatively short time and to improve the productivity.

By printing an image with the head chips Hc1 and Hc2 having a low ejection ability, it is possible to eject small ink droplets onto the medium S, and to improve the image quality of the image formed at the medium S.

It is possible to perform printing that achieves both high productivity and high image quality, by ejecting ink droplets from the head chips Hc3 and Hc4 to a portion having a relatively wide area to be filled and ejecting ink droplets from the head chips Hc1 and Hc2 to a portion requiring high image quality in an image formed on one medium S.

By providing the head chips Hc having different ejection abilities in one liquid ejecting head H in this manner, as compared with a case where liquid ejecting heads H having the respective head chips Hc with different ejection abilities are separately provided, it is possible to reduce the number of liquid ejecting heads H and to reduce the size of the liquid ejecting head H and the size of the liquid ejecting apparatus 1. When one liquid ejecting head H is provided with only the head chip Hc having the same ejection ability, two liquid ejecting heads H, that is, the liquid ejecting head H that can perform high-productivity printing and the liquid ejecting head H that can perform high-quality printing, are required to be provided. In the present embodiment, by mixing the head chips Hc having different ejection abilities in one liquid ejecting head H, it is possible to reduce the number of the liquid ejecting heads H and to reduce the size of the entire liquid ejecting head H. In addition, it is possible to achieve both high productivity and high image quality and to improve the expandability of the liquid ejecting head H and the expandability of the liquid ejecting apparatus 1.

In the present embodiment, it is assumed that the head chips Hc1 to Hc4 are disposed in this order in the +Y direction, but the arrangement order of the head chips Hc1 to Hc4 is not particularly limited thereto.

As described above, since the head chips Hc1 to Hc4 are compatible with each other, it is possible to easily change and optimize the arrangement order of the head chips Hc1 to Hc4 in accordance with the purpose and application.

In the present embodiment, the head chips Hc1 and Hc2 correspond to the “first head chip”, and the head chips Hc3 and Hc4 correspond to the “second head chip”. Further, in the present embodiment, the Y-axis direction corresponds to the “main scanning direction”, and the +X direction corresponds to the “transport direction”. In the present embodiment, the space defined by the accommodation portion 208 and the cover head 220 corresponds to the “accommodation space”, and corresponds to the “first accommodation space” and the “second accommodation space”.

### First Modification Example

FIG. 10 is a schematic view of a liquid ejecting head H in a first modification example of the first embodiment when viewed in the +Z direction.

The liquid ejecting head H in the present modification example is different from that of the first embodiment in the ejection abilities of the head chips Hc1 to Hc4.

As illustrated in FIG. 10, in the liquid ejecting head H of the present modification example, four head chips Hc are arranged side by side in the Y-axis direction at the same position in the X-axis direction, as in the first embodiment. Each head chip Hc has two nozzle rows 22 as in the first embodiment described above. The nozzle row 22 in the −Y direction is referred to as a nozzle row 22A, and the nozzle row 22 in the +Y direction is referred to as a nozzle row 22B.

When the nozzle rows 22A and 22B are not distinguished from each other, the nozzle rows are referred to as the nozzle row 22 below.

In the present modification example, the four head chips Hc are sequentially referred to as a head chip Hc1, a head chip Hc2, a head chip Hc3, and a head chip Hc4 in the +Y direction. When the head chips Hc1 to Hc4 are not distinguished from each other, the head chips Hc1 to Hc4 are referred to as the head chip Hc below. The head chips Hc1 to Hc4 are compatible with each other.

The head chips Hc1 and Hc4 have a higher ejection ability than the head chips Hc2 and Hc3. In other words, the head chip Hc1 having a relatively high ejection ability is disposed at one end in the −Y direction, and the head chip Hc4 having a relatively high ejection ability is disposed in the +Y direction. The head chips Hc2 and Hc3 are disposed between the head chip Hc1 and the head chip Hc4 in the Y-axis direction.

In such a liquid ejecting head H, printing is performed in a manner that a pre-treatment liquid is ejected from the head chip Hc4, inks containing coloring materials, for example, the four colors of inks are ejected from the head chips Hc2 and Hc3, and a post-treatment liquid is ejected from the head chip Hc1. That is, when printing is performed while moving the liquid ejecting head H in the +Y direction, the pre-treatment liquid is applied onto the medium S by the head chip Hc4, and then an image is printed on the medium S by ejecting the inks containing the coloring materials (in the present modification example, the four colors of inks) from the head chips Hc2 and Hc3 on the pre-treatment liquid. Then, the post-treatment liquid is applied onto the image by the head chip Hc1. By causing the head chips Hc4 and Hc1 having a high ejection ability to apply the pre-treatment liquid and the post-treatment liquid as described above, it is easy to perform so-called solid printing in which a relatively wide area is covered with the treatment liquid, and thus it is possible to improve the productivity. Further, by causing the head chips Hc2 and Hc3 having a low ejection ability to eject the inks containing the coloring materials, it is possible to improve the image quality of the printed image. That is, by mixing the head chips Hc having different ejection abilities in one liquid ejecting head H, it is possible to reduce the size of the liquid ejecting head H. In addition, it is possible to achieve both high productivity and high image quality and to improve the expandability of the liquid ejecting head H and the expandability of the liquid ejecting apparatus 1.

In addition, in the present modification example, in one path printing in which printing is performed while moving the liquid ejecting head H in the +Y direction, it is possible to perform printing while following the order of ejecting the pre-treatment liquid, the ink containing the coloring material, and the post-treatment liquid. Therefore, it is not necessary to move the liquid ejecting head H in the Y-axis direction many times, and it is possible to shorten the printing time.

Examples of the pre-treatment liquid include a reaction liquid that aggregates a coloring material such as a pigment, and a white ink. Examples of the post-treatment liquid include an overcoat liquid and the like.

In the present modification example, the head chips Hc1 and Hc4 correspond to the “second head chip”, and the head chips Hc2 and Hc3 correspond to the “first head chip”. In the present modification example, the head chip Hc4 corresponds to the “second head chip A”, and the head chip Hc1 corresponds to the “second head chip B”. Further, in the present embodiment, the Y-axis direction corresponds to the “main scanning direction”, and the +X direction corresponds to the “transport direction”.

### Second Modification Example

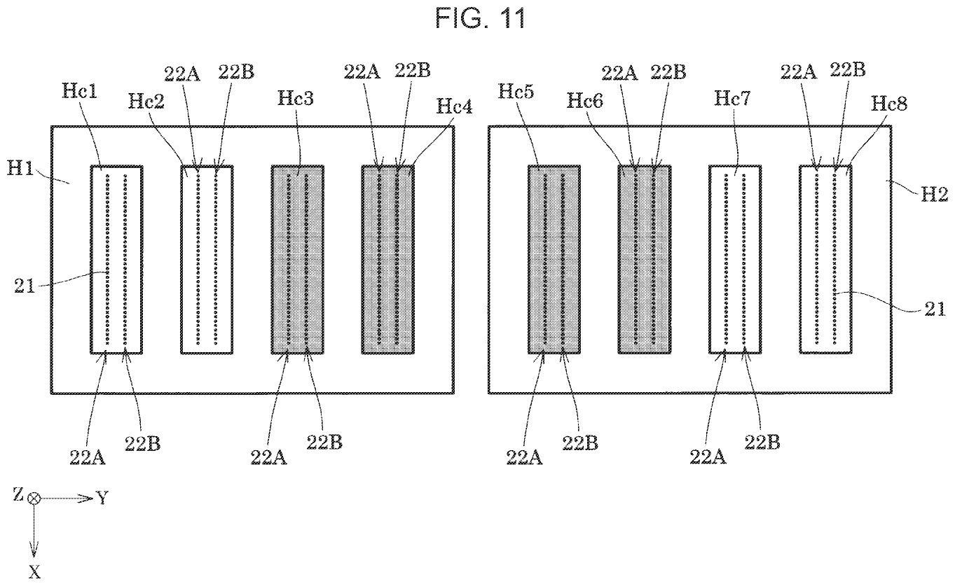

FIG. 11 is a schematic view of two liquid ejecting heads H provided in a liquid ejecting apparatus 1 in a second modification example of the first embodiment when viewed in the +Z direction. The present modification example is different from the first modification example in that the liquid ejecting apparatus 1 includes two liquid ejecting heads H.

That is, in the present modification example, the support member 7 (refer to FIG. 1) holds the two liquid ejecting heads H. The two liquid ejecting heads H are arranged side by side in the Y-axis direction to have the same position in the X-axis direction. Here, the phrase that two liquid ejecting heads H are provided at the same position in the X-axis direction means that nozzles 21 of a head chips Hc in each of the two liquid ejecting heads H are provided at the same position in the X-axis direction.

In the present modification example, among the two liquid ejecting heads H, the liquid ejecting head H provided in the −Y direction is referred to as a liquid ejecting head H1, and the liquid ejecting head H provided in the +Y direction is referred to as a liquid ejecting head H2. When the liquid ejecting heads H1 and H2 are not distinguished from each other, the liquid ejecting heads H1 and H2 are referred to as the liquid ejecting head H below.

In each liquid ejecting head H, four head chips Hc are arranged side by side in the Y-axis direction at the same position in the X-axis direction, as in the first embodiment. Each head chip Hc is provided with two nozzle rows 22 as in the first embodiment described above. Nozzle rows 22A and 22B may be disposed to deviate from each other by a half pitch in the X-axis direction. That is, the nozzles 21 may be disposed in a staggered manner along the X-axis direction.

The four head chips Hc of the liquid ejecting head H1 are sequentially referred to as head chips Hc1 to Hc4 in the +Y direction. Further, the four head chips Hc of the liquid ejecting head H2 are sequentially referred to as head chips Hc5 to Hc8 in the +Y direction. When the head chips Hc1 to Hc8 are not distinguished from each other, the head chips Hc1 to Hc8 are referred to as the head chip Hc below. The head chips Hc1 to Hc8 are compatible with each other.

In the liquid ejecting head H1, the head chips Hc1 and Hc2 have a higher ejection ability than the head chips Hc3 and Hc4. In the liquid ejecting head H2, the head chips Hc7 and Hc8 have a higher ejection ability than the head chips Hc5 and Hc6. The head chips Hc1, Hc2, Hc7, and Hc8 have substantially the same ejection ability, and the head chips Hc3 to Hc6 have substantially the same ejection ability.

That is, the head chips Hc3 and Hc4 in the liquid ejecting head H1 are disposed between the head chips Hc1 and Hc2 in the liquid ejecting head H1 and the liquid ejecting head H2 in the +Y direction.

The head chips Hc5 and Hc6 in the liquid ejecting head H2 are disposed between the head chips Hc7 and Hc8 in the liquid ejecting head H2 and the liquid ejecting head H1 in the +Y direction.

At the time of printing, the pre-treatment liquid is ejected from the head chips Hc7 and Hc8. In addition, inks containing different coloring materials, for example, four colors of inks are ejected from the head chips Hc3 to Hc6. The post-treatment liquid is ejected from the head chips Hc1 and Hc2. That is, when printing is performed while moving the liquid ejecting heads H1 and H2 in the +Y direction, the pre-treatment liquid is applied onto a medium S by the head chips Hc7 and Hc8, and then an image is printed on the medium S by ejecting the four colors of inks from the head chips Hc3 to Hc6 on the pre-treatment liquid. Then, the post-treatment liquid is applied onto the image by the head chips Hc1 and Hc2. By causing the head chips Hc1, Hc2, Hc7, and Hc8 having such a high ejection ability to apply the pre-treatment liquid and the post-treatment liquid having a relatively large application area in this manner, it is possible to improve the productivity. Further, by causing the head chips Hc3 to Hc6 having a low ejection ability that enables small dots to be formed at the medium S to eject the inks containing the coloring materials, it is possible to improve the image quality.

Further, by mixing the head chips Hc having different ejection abilities in the liquid ejecting head H, it is possible to reduce the number of the liquid ejecting heads H. For example, when only the head chip Hc having the same ejection ability is mounted on the liquid ejecting head H, three liquid ejecting heads H are required: the liquid ejecting head H mounted with the head chip Hc having a high ejection ability for ejecting the pre-treatment liquid; the liquid ejecting head H mounted only with the head chip Hc having a low ejection ability for ejecting the ink containing the coloring material; and the liquid ejecting head H mounted with the head chip Hc having a high ejection ability for ejecting the post-treatment liquid. On the other hand, as in the present modification example, by mounting the head chips Hc having different ejection abilities on one liquid ejecting head H in a mixed manner, printing can be performed in a manner that the two liquid ejecting heads H eject the pre-treatment liquid, the ink containing the coloring material, and the post-treatment liquid, and it is possible to achieve both high productivity and high image quality. Therefore, it is possible to reduce the number of liquid ejecting heads H, and thus to reduce the size of the liquid ejecting apparatus 1.

In addition, in the present modification example, in one path printing in which printing is performed while moving the two liquid ejecting heads H in the +Y direction, it is possible to perform printing while following the order of ejecting the pre-treatment liquid, the ink containing the coloring material, and the post-treatment liquid. Therefore, it is not necessary to move the liquid ejecting head H in the Y-axis direction many times, and it is possible to shorten the printing time.

In the present modification example, the head chips Hc1, Hc2, Hc7, and Hc8 correspond to the “second head chip”, and the head chips Hc3 to Hc6 correspond to the “first head chip”. Further, in the present modification example, the liquid ejecting head H1 corresponds to a “first liquid ejecting head” and the liquid ejecting head H2 corresponds to a “second liquid ejecting head”. Further, in the present embodiment, the Y-axis direction corresponds to the “main scanning direction”, and the +X direction corresponds to the “transport direction”.

### Third Modification Example

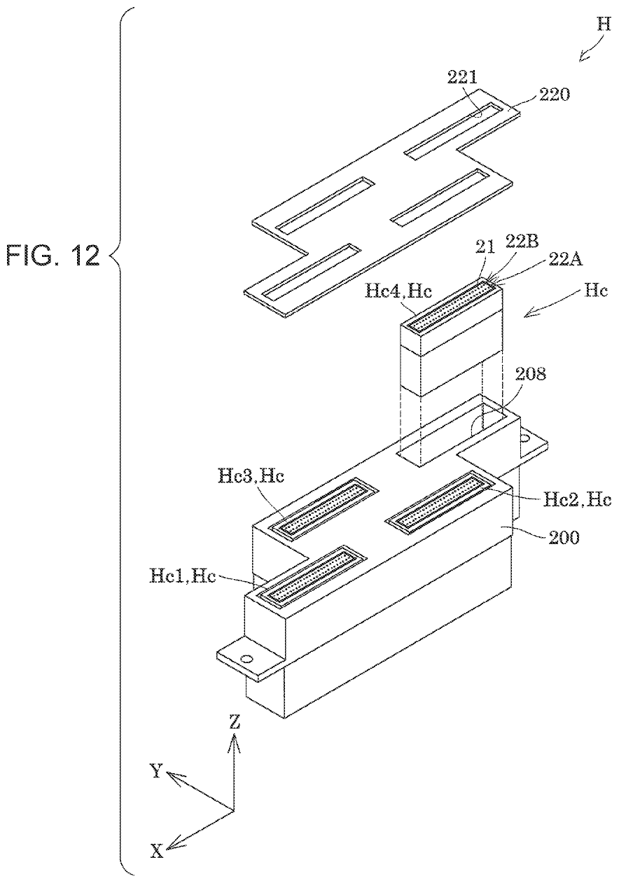

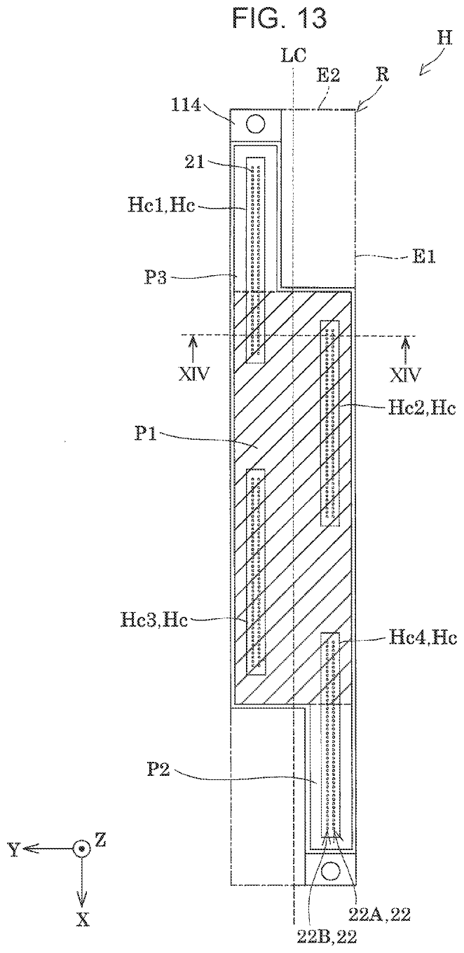

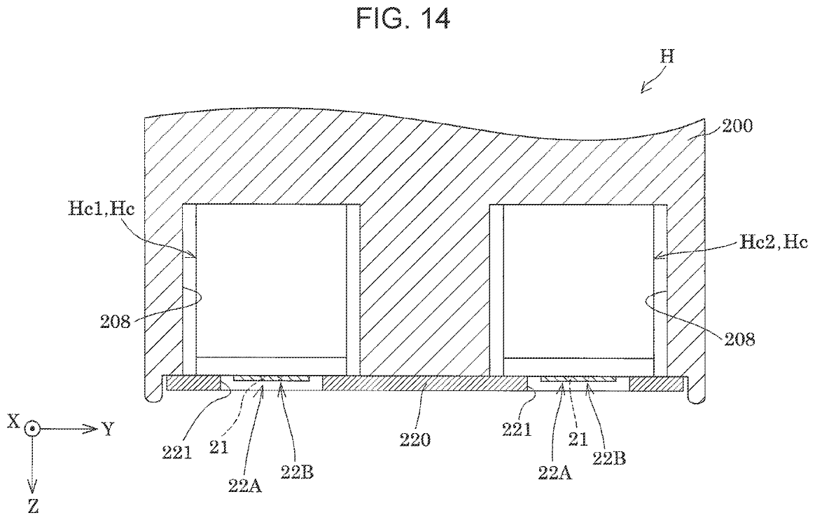

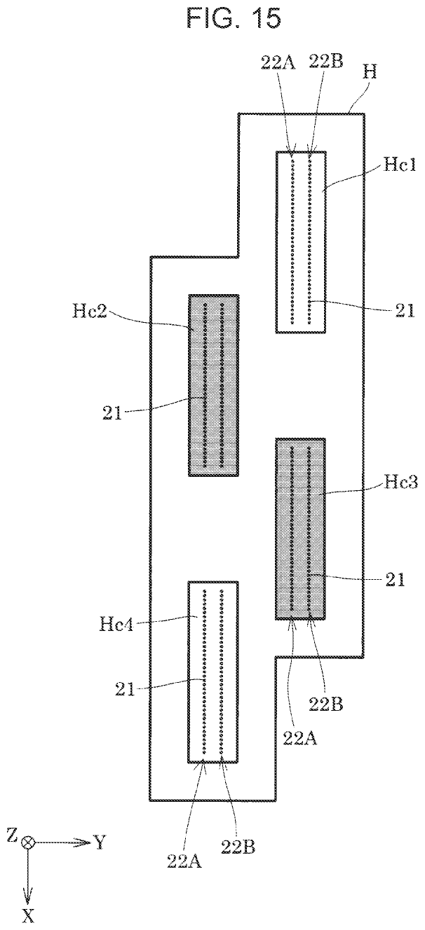

FIG. 12 is an exploded perspective view of a liquid ejecting head H in a third modification example of the first embodiment when viewed in the −Z direction. FIG. 13 is a plan view of the liquid ejecting head H when viewed in the −Z direction. FIG. 14 is a cross-sectional view taken along the line XIV-XIV of FIG. 13. FIG. 15 is a schematic view of the liquid ejecting head H when viewed in the +Z direction.

The present modification example is different from the first embodiment in that head chips Hc are arranged in a staggered manner along the Y-axis direction. As illustrated in FIGS. 12 to 15, the liquid ejecting head H includes a plurality of head chips Hc, a flow path member 200, and a cover head 220.

The flow path member 200 is provided with a flow path 400 (not illustrated) inside. The flow path 400 is provided independently for each nozzle row of each head chip Hc. In addition, an accommodation portion 208 that individually accommodates the head chip Hc is provided on the surface of the flow path member 200 facing the +Z direction. The accommodation portion 208 has a recessed shape that is open on the surface in the +Z direction. In the present modification example, the accommodation portion 208 is provided independently for each head chip Hc, but may be continuously provided over the plurality of head chips Hc as in the first embodiment described above. The cover head 220 is provided on the surface of the flow path member 200 in the +Z direction and closes a portion of the opening of the accommodation portion 208. The cover head 220 is the similar member to that in the first embodiment described above.

The head chip Hc has two nozzle rows 22 arranged side by side in the Y-axis direction. The nozzle row 22 in the −Y direction is referred to as a nozzle row 22A, and the nozzle row 22 in the +Y direction is referred to as a nozzle row 22B. When the nozzle row 22A and the nozzle row 22B are not distinguished from each other, the nozzle row 22A and the nozzle row 22B are referred to as the nozzle row 22 below.

Four such head chips Hc are provided along the X-axis direction. The four head chips Hc are arranged in a staggered manner along the +X direction. Here, the phrase that the plurality of head chips Hc are arranged in a staggered manner along the +X direction means that the head chips Hc arranged side by side in the +X direction are alternately disposed to deviate from each other in the Y-axis direction. In other words, two rows of the head chips Hc arranged side by side in the +X direction are arranged side by side in the +Y direction, and two rows of head chips Hc are disposed to deviate from each other in the +X direction by a half pitch. By arranging the plurality of head chips Hc in a staggered manner along the +X direction in this manner, the nozzle rows 22 of the two head chips Hc can be partially overlapped in the X-axis direction to form a row of nozzles 21 that is continuous in the +X direction.

As illustrated in FIG. 13, the liquid ejecting head H includes a first portion P1 (a part indicated by hatching), a second portion P2, and a third portion P3 when viewed in the −Z direction. When the liquid ejecting head H is viewed in a plan view in the +Z direction and a rectangle having the minimum area including the liquid ejecting head H is set as R, a long side E1 of the rectangle R overlaps a side of the outer periphery of the liquid ejecting head H along the +X direction, and a short side E2 of the rectangle R overlaps a side of the outer periphery of the liquid ejecting head H along the +Y direction. The center line parallel to the long side E1 of the virtual rectangle R is set to LC.

The first portion P1 is a rectangular portion through which the center line LC passes. The second portion P2 is a rectangular portion protruding from the first portion P1 in the +X direction. The third portion P3 is a rectangular portion protruding from the first portion P1 in the −X direction. That is, the second portion P2, the first portion P1, and the third portion P3 are arranged in this order in the −X direction.

The second portion P2 and the third portion P3 are located in opposite directions along the Y axis with the center line LC interposed therebetween. Then, for example, when two liquid ejecting heads H are arranged in the X-axis direction, the plurality of liquid ejecting heads H are arranged in the X-axis direction such that the second portion P2 of one liquid ejecting head H and the third portion P3 of the other liquid ejecting head H among the two liquid ejecting heads H face each other in the Y-axis direction. In this manner, by disposing the second portion P2 of one liquid ejecting head H and the third portion P3 of the other liquid ejecting head H to face each other in the Y-axis direction, the nozzles 21 of the liquid ejecting heads H that are adjacent to each other along the X-axis direction can be partially overlapped in the X-axis direction to form a row of nozzles 21 that is continuous in the X-axis direction. The second portion P2 and the third portion P3 have a width in the Y-axis direction that does not pass through the center line LC. Therefore, when the plurality of liquid ejecting heads H are arranged in the X-axis direction, it is possible to further narrow the width occupied by the plurality of liquid ejecting heads H in the Y-axis direction. When only one liquid ejecting head H is used in a liquid ejecting apparatus 1, the liquid ejecting head H may be set to have a rectangular shape when viewed in the −Z direction, but the liquid ejecting apparatus 1 is required to be manufactured by the single liquid ejecting head H and the liquid ejecting head H in which two or more liquid ejecting heads H are arranged in the X-axis direction.

Therefore, by using the liquid ejecting head H in the present modification example, which is not limited in the number of liquid ejecting heads to be used, it is not necessary to dedicatedly manufacture the liquid ejecting head H, and it is possible to share the components, and to reduce the cost.

In the present modification example, the four head chips Hc arranged side by side in the X-axis direction are sequentially referred to as a head chip Hc1, a head chip Hc2, a head chip Hc3, and a head chip Hc4 in the +X direction. When the head chips Hc1 to Hc4 are not distinguished from each other, the head chips Hc1 to Hc4 are referred to as the head chip Hc below.

The head chips Hc1 to Hc4 are compatible with each other. That is, other head chips Hc can be accommodated in an accommodation space defined by an accommodation portion 208 that accommodates any one head chip Hc and the cover head 220.

The head chips Hc1 and Hc4 have a higher ejection ability than the head chips Hc2 and Hc3. The head chip Hc1 and the head chip Hc4 have substantially the same ejection ability, and the head chip Hc2 and the head chip Hc3 have substantially the same ejection ability.

That is, the liquid ejecting head H includes the head chip Hc1 disposed at one end, that is, at one end in the −X direction, and the head chip Hc4 disposed at the other end, that is, at one end in the +X direction. The head chips Hc2 and Hc3 are disposed between the head chip Hc1 and the head chip Hc4 in the +X direction.

At the time of printing, the pre-treatment liquid is ejected from the head chip Hc1. In addition, inks containing coloring materials, for example, four colors of inks are ejected from the head chips Hc2 and Hc3. The post-treatment liquid is ejected from the head chip Hc4. When printing is performed by causing the liquid ejecting head H to reciprocate in the Y-axis direction while moving a medium S in the +X direction, the pre-treatment liquid is applied onto the medium S by the head chip Hc1, and then an image is printed on the medium S by ejecting the four colors of inks from the head chips Hc2 and Hc3. Then, the post-treatment liquid can be applied onto the image by the head chip Hc4. That is, by disposing the head chip Hc having a high ejection ability at both the upstream and the downstream in the +X direction, which is the transport direction of the medium S, it is possible to perform printing while following the order of ejecting the pre-treatment liquid, the ink containing the coloring material, and the post-treatment liquid, in a direction in which the medium S is transported in the +X direction. Therefore, it is not necessary to cause the medium S to reciprocate in the X-axis direction, and it is possible to shorten the printing time.

Further, each of the head chips Hc1 and Hc4 that eject the pre-treatment liquid or the post-treatment liquid has two nozzle rows 22 more than the number of nozzle rows 22 (one row in the present modification example) corresponding to one type of ink. Therefore, it is easy to perform so-called solid printing in which a wide area is covered with the treatment liquid.

In the present modification example, it is assumed that the nozzle rows 22 of the two head chips Hc that are adjacent to each other in the X-axis direction are partially overlapped in the X-axis direction, but the present modification example is not particularly limited thereto. The head chips Hc may be disposed such that the nozzle rows 22 of two head chips Hc that are adjacent to each other in the X-axis direction do not overlap each other in the X-axis direction. However, as in the present modification example, by using the liquid ejecting head H including the head chips Hc in which the nozzle rows 22 of the two head chips Hc that are adjacent to each other in the X-axis direction are partially overlapped in the X-axis direction, it is possible to share the components with other liquid ejecting heads H that require a nozzle row that is continuous in the X-axis direction, and it is possible to reduce the cost.

In the present modification example, the head chips Hc1 and Hc4 correspond to the “second head chip”, and the head chips Hc2 and Hc3 correspond to the “first head chip”. In the present modification example, the head chip Hc1 corresponds to the “second head chip A”, and the head chip Hc4 corresponds to the “second head chip B”. Further, in the present embodiment, the Y-axis direction corresponds to the “main scanning direction”, and the +X direction corresponds to the “transport direction”. Further, the accommodation space defined by the cover head 220 and the accommodation portion 208 in which the head chips Hc1 and Hc4 are accommodated corresponds to the “second accommodation space”, and the accommodation space defined by the cover head 220 and the accommodation portion 208 in which the head chips Hc2 and Hc3 are accommodated corresponds to the “first accommodation space”.

### Fourth Modification Example

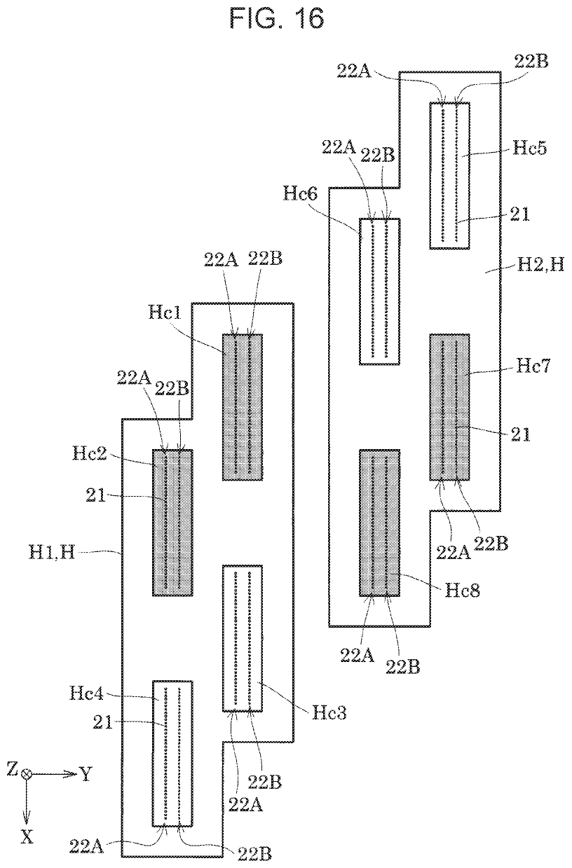

FIG. 16 is a schematic view of two liquid ejecting heads H provided in a liquid ejecting apparatus 1 in a fourth modification example of the first embodiment when viewed in the +Z direction. The present modification example is different from the third modification example in that the liquid ejecting apparatus 1 includes two liquid ejecting heads H.

As illustrated in FIG. 16, the support member 7 (refer to FIG. 1) holds the two liquid ejecting heads H. The two liquid ejecting heads H are arranged side by side in the Y-axis direction. In the present modification example, among the two liquid ejecting heads H, the liquid ejecting head H disposed in the −Y direction is referred to as a liquid ejecting head H1, and the liquid ejecting head H disposed in the +Y direction is referred to as a liquid ejecting head H2. When the liquid ejecting heads H1 and H2 are not distinguished from each other, the liquid ejecting heads H1 and H2 are referred to as the liquid ejecting head H below. Since each liquid ejecting head H is the same as that in the third modification example described above, the repetitive description will be omitted.

In the present modification example, four head chips Hc of the liquid ejecting head H1 are sequentially referred to as a head chip Hc1, a head chip Hc2, a head chip Hc3, and a head chip Hc4 in the +X direction. In addition, four head chips Hc of the liquid ejecting head H2 are sequentially referred to as a head chip Hc5, a head chip Hc6, a head chip Hc7, and a head chip Hc8 in the +X direction. When the head chips Hc1 to Hc8 are not distinguished from each other, the head chips Hc1 to Hc8 are referred to as the head chip Hc below.

The liquid ejecting head H1 and the liquid ejecting head H2 are disposed such that the head chip Hc1 and the head chip Hc7 are located at the same position in the X-axis direction. Further, the head chip Hc2 and the head chip Hc8 are disposed to be located at the same position in the X-axis direction. Here, the phrase that the two head chips Hc are provided at the same position in the X-axis direction means that the positions of the nozzles 21 of the two head chips Hc are substantially the same in the X-axis direction.

The head chips Hc1 to Hc8 are compatible with each other.

In the liquid ejecting head H1, the head chips Hc3 and Hc4 have a higher ejection ability than the head chips Hc1 and Hc2. In the liquid ejecting head H2, the head chips Hc5 and Hc6 have a higher ejection ability than the head chips Hc7 and Hc8. The head chips Hc3 to Hc6 have substantially the same ejection ability, and the head chips Hc1, Hc2, Hc7, and Hc8 have substantially the same ejection ability.

At the time of printing, the pre-treatment liquid is ejected from the head chips Hc5 and Hc6. Further, inks containing different coloring materials are ejected from the head chips Hc1, Hc2, Hc7, and Hc8. The post-treatment liquid is ejected from the head chips Hc3 and Hc4. In the present modification example, two colors of inks are ejected from each of the head chips Hc1 and Hc2. That is, the same ink is ejected from each of the nozzle rows 22A of the head chips Hc1 and Hc2.

Further, the same ink is ejected from each of the nozzle rows 22B of the head chips Hc1 and Hc2. Similarly, two colors of inks are ejected from each of the head chips Hc7 and Hc8. The two colors of inks ejected from the head chips Hc7 and Hc8 are inks having colors different from the inks ejected from the head chips Hc1 and Hc2. Thus, color printing can be performed in a manner that the four head chips Hc eject four colors of inks. Further, when printing is performed by moving the two liquid ejecting heads H in the Y-axis direction, printing can be performed by the length of the nozzle rows 22 of the two head chips Hc in the X-axis direction.

In such a configuration, printing is performed while moving the liquid ejecting heads H1 and H2 in the +Y direction. That is, the pre-treatment liquid is applied onto the medium S by the head chips Hc5 and Hc6, and then an image is printed on the medium S by ejecting the four colors of inks from the head chips Hc1, Hc2, Hc7, and Hc8 onto the pre-treatment liquid. Then, the post-treatment liquid is applied onto the image by the head chips Hc3 and Hc4. By causing the head chips Hc3 to Hc6 having such a high ejection ability to apply the pre-treatment liquid and the post-treatment liquid having a relatively large coating area in this manner, it is possible to improve the productivity. Further, by causing the head chips Hc1, Hc2, Hc7, and Hc8 having a low ejection ability to eject the inks containing the coloring materials, it is possible to improve the image quality.

Further, by mixing the head chips Hc having different ejection abilities in the liquid ejecting head H, it is possible to reduce the number of the liquid ejecting heads H. For example, when only the head chip Hc having the same ejection ability is mounted on the liquid ejecting head H, three liquid ejecting heads H are required: the liquid ejecting head H mounted with the head chip Hc having a high ejection ability for ejecting the pre-treatment liquid; the liquid ejecting head H mounted only with the head chip Hc having a low ejection ability for ejecting the ink containing the coloring material; and the liquid ejecting head H mounted with the head chip Hc having a high ejection ability for ejecting the post-treatment liquid. On the other hand, as in the present modification example, by mounting the head chips Hc having different ejection abilities on one liquid ejecting head H in a mixed manner, printing can be performed in a manner that the two liquid ejecting heads H eject the pre-treatment liquid, the ink containing the coloring material, and the post-treatment liquid, and it is possible to achieve both high productivity and high image quality. Therefore, it is possible to reduce the number of liquid ejecting heads H, and thus to reduce the size of the liquid ejecting apparatus 1.

In addition, in the present modification example, in one path printing in which printing is performed while moving the two liquid ejecting heads H in the +Y direction, it is possible to perform printing while following the order of ejecting the pre-treatment liquid, the ink containing the coloring material, and the post-treatment liquid. Therefore, it is not necessary to move the liquid ejecting head H in the Y-axis direction many times, and it is possible to shorten the printing time.

In the present modification example, the head chips Hc1, Hc2, Hc7, and Hc8 correspond to the “first head chip”, and the head chips Hc3 to Hc6 correspond to the “second head chip”. Further, in the present modification example, the liquid ejecting head H1 corresponds to a “first liquid ejecting head” and the liquid ejecting head H2 corresponds to a “second liquid ejecting head”. Further, in the present embodiment, the Y-axis direction corresponds to the “main scanning direction”, and the +X direction corresponds to the “transport direction”.

### Fifth Modification Example

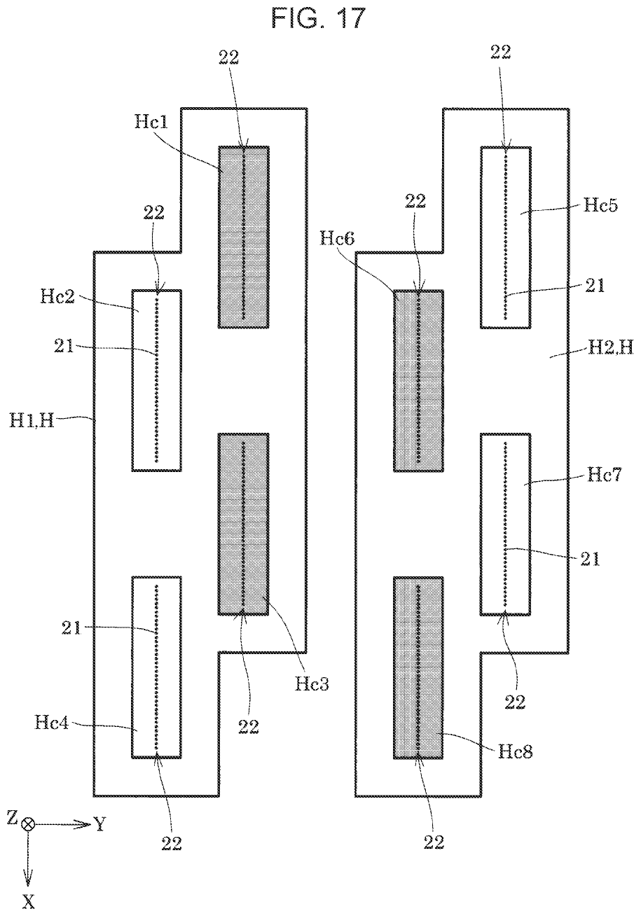

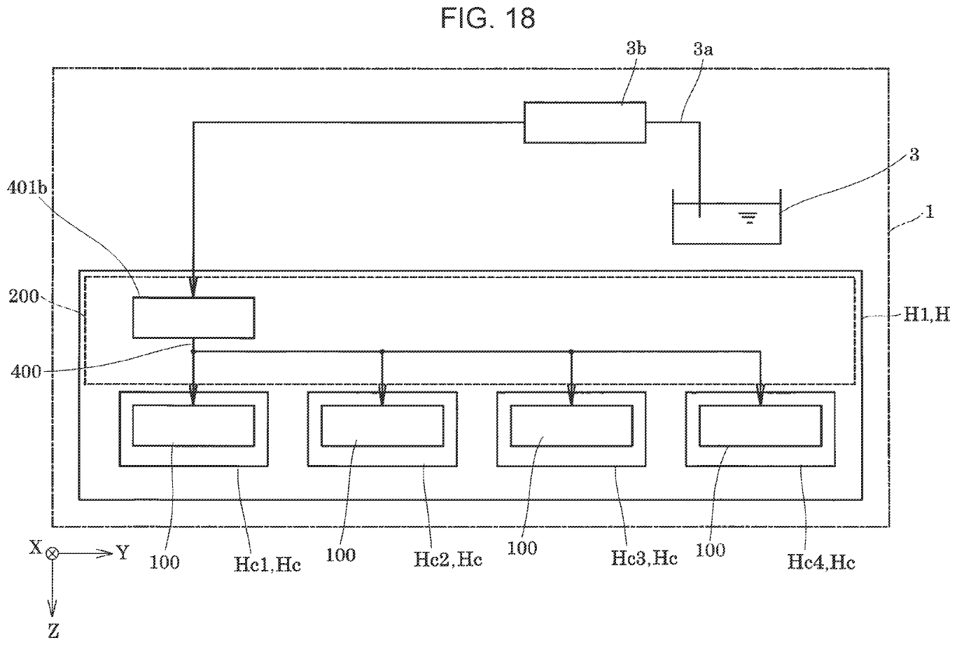

FIG. 17 is a schematic view of two liquid ejecting heads H provided in a liquid ejecting apparatus 1 in a fifth modification example of the first embodiment when viewed in the +Z direction. The present modification example is different from the fourth modification example in the disposition of the liquid ejecting heads H and the disposition of the head chips Hc having different ejection abilities, and the present modification example is different from the fourth modification example in that the head chip Hc has only one nozzle row 22.

As illustrated in FIG. 17, in the present modification example, a support member 7 (not illustrated) holds two liquid ejecting heads H. The two liquid ejecting heads H are arranged side by side in the Y-axis direction to have the same position in the X-axis direction. Here, the phrase that two liquid ejecting heads H are provided at the same position in the X-axis direction means that nozzles 21 of a head chips Hc in each of the two liquid ejecting heads H are provided at the same position in the X-axis direction.

In the present modification example, among the two liquid ejecting heads H, the liquid ejecting head H in the −Y direction is referred to as a liquid ejecting head H1, and the liquid ejecting head H in the +Y direction is referred to as a liquid ejecting head H2. When the liquid ejecting heads H1 and H2 are not distinguished from each other, the liquid ejecting heads H1 and H2 are referred to as the liquid ejecting head H below.

Since the configuration in which each of the liquid ejecting heads H is provided with four head chips Hc is the same as that in the fourth modification example described above, the repetitive description will be omitted.

The four head chips Hc of the liquid ejecting head H1 are sequentially referred to as a head chip Hc1, a head chip Hc2, a head chip Hc3, and a head chip Hc4 in the +X direction. In addition, the four head chips Hc of the liquid ejecting head H2 are sequentially referred to as a head chip Hc5, a head chip Hc6, a head chip Hc7, and a head chip Hc8 in the +X direction. When the head chips Hc1 to Hc8 are not distinguished from each other, the head chips Hc1 to Hc8 are referred to as the head chip Hc below.

In the liquid ejecting head H1, the head chips Hc2 and Hc4 have a higher ejection ability than the head chips Hc1 and Hc3. In the liquid ejecting head H2, the head chips Hc5 and Hc7 have a higher ejection ability than the head chips Hc6 and Hc8. The head chips Hc2, Hc4, Hc5, and Hc7 have substantially the same ejection ability, and the head chips Hc1, Hc3, Hc6, and Hc8 have substantially the same ejection ability.

Each head chips Hc has one nozzle row 22. The same ink is ejected from the respective nozzle rows 22 of the head chips Hc1 to Hc4 in the liquid ejecting head H1 and the head chips Hc5 to Hc8 in the liquid ejecting head H2. Each head chip Hc may have two nozzle rows 22.

A configuration of a flow path in the liquid ejecting apparatus 1 including such a liquid ejecting head H will be described with reference to FIG. 18. FIG. 18 is a schematic view illustrating the configuration of the flow path of the liquid ejecting apparatus 1 in the fifth modification example. Although FIG. 18 illustrates the configuration of the flow path for an ink to be supplied to the liquid ejecting head H1, the liquid ejecting head H2 has the similar configuration.

As illustrated in FIG. 18, a flow path 400 is provided in a flow path member 200 of the liquid ejecting head H. One end of the flow path 400 is coupled to a liquid storage section 3, and the other end is branched into four pieces in the middle and the branched pieces are coupled to the four head chips Hc. A filter 401b is provided in a portion of the flow path 400 before branched.

The ink from the liquid storage section 3 is supplied to the liquid ejecting head H via a supply pipe 3a such as a tube. A pump 3b that is a pressure-feeding unit that pressure-feeds the ink to the liquid ejecting head H is provided in the middle of the supply pipe 3a. The pressure-feeding unit is not limited to the pump 3b. A pressing unit that presses the liquid storage section 3 from the outside may be used, or a water head pressure difference generated by adjusting a relative position in the vertical direction between the liquid ejecting head H and the liquid storage section 3 may be used.

In such a configuration in which one ink is branched into a plurality of pieces and the branched pieces are supplied to the plurality of head chips Hc, when the liquid ejecting head H ejects the ink while moving in the +Y direction, ink droplets are first ejected from the head chips Hc5 and Hc7, and then ink droplets are ejected from the head chips Hc6 and Hc8. Thus, the ink is landed on the same position in the medium S in the Y-axis direction. At this time, the negative pressure in the flow path generated by ejecting the ink droplets from the head chips Hc5 and Hc7 acts on the head chips Hc6 and Hc8 via the common flow path 400. Similarly, ink droplets are ejected first from the head chips Hc1 and Hc3, and then ink droplets are ejected from the head chips Hc2 and Hc4. Thus, the ink is landed on the same position in the medium S in the Y-axis direction. At this time, the negative pressure in the flow path generated by ejecting the ink droplets from the head chips Hc1 and Hc3 acts on the head chips Hc2 and Hc4 via the common flow path 400. As a result, the ejection weight of the ink droplets ejected from the head chips Hc6 and Hc8 and the head chips Hc2 and Hc4 decreases, and the dot size formed at the medium S becomes smaller. However, with the disposition of the head chips Hc as in the present modification example, it is possible to suppress an occurrence of the density unevenness due to the boundary portion.

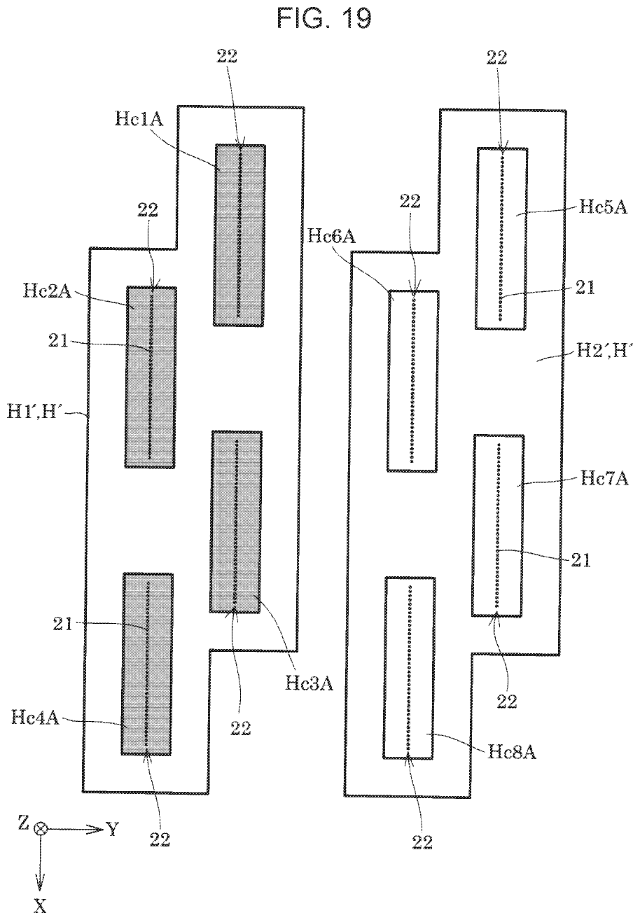

Here, FIG. 19 illustrates an example when a head chip having substantially the same ejection characteristic is provided in one liquid ejecting head H′. FIG. 19 is a schematic view of a liquid ejecting head HA in a comparative example when viewed in the +Z direction.

As illustrated in FIG. 19, a liquid ejecting head H1′ disposed in the −Y direction includes four head chips Hc, and a liquid ejecting head H2′ disposed in the +Y direction includes four head chips Hc.

The head chips Hc of the liquid ejecting head H1′ are sequentially referred to as a head chip Hc1A, a head chip Hc2A, a head chip Hc3A, and a head chip Hc4A in the +X direction. In addition, the head chips Hc of the liquid ejecting head H2′ are sequentially referred to as a head chip Hc5A, a head chip Hc6A, a head chip Hc7A, and a head chip Hc8A in the +X direction.

The head chip Hc of the liquid ejecting head H2′ has higher ejection characteristics than the head chip Hc of the liquid ejecting head H1′.

With such a configuration, when an ink is supplied with the same configuration as the configuration of the flow path illustrated in FIG. 18 and printing is performed with the ink having a large ejection weight, that is, by the liquid ejecting head H2′, the ink is first ejected from the head chips Hc5A and Hc7A, and then the ink is ejected from the head chips Hc6A and Hc8A. Thus, the ink is landed on the same position in the medium S in the Y-axis direction. At this time, the large negative pressure in a flow path generated by ejecting ink droplets from the head chips Hc5A and Hc7A acts on the head chips Hc6A and Hc8A via a common flow path 400. As a result, the ejection weight of the ink droplets ejected from the head chips Hc6A and Hc8A is largely reduced as compared with the ejection weight of the ink droplets ejected from the head chips Hc5A and Hc7A. Therefore, in the medium S, the density unevenness is likely to occur at the boundary portion between a portion at which printing was performed by the head chips Hc5A and Hc7A and a portion at which printing was performed by the head chip Hc6A and Hc8A.

On the other hand, in the present modification example, printing is performed with an ink having a large ejection weight, by the head chips Hc2 and Hc4 in the liquid ejecting head H1 and the head chips Hc5 and Hc7 in the liquid ejecting head H2. At this time, since the head chips Hc2 and Hc4 eject ink droplets after ink droplets are ejected from the head chips Hc1 and Hc3 having a relatively small ejection weight, the influence of the negative pressure is relatively small, and it is possible to suppress the decrease in the ejection weight. Therefore, it is possible to suppress the occurrence of the density unevenness at the boundary portion between a portion at which printing was performed by the head chips Hc2 and Hc4 and a portion at which printing was performed by the head chip Hc5 and Hc7, in the medium S.

Further, in the present modification example, printing is performed with the ink having a small ejection weight by the head chips Hc1 and Hc3 in the liquid ejecting head H1 and the head chips Hc6 and Hc8 in the liquid ejecting head H2. At this time, since the head chips Hc6 and Hc8 eject ink droplets after ink droplets are ejected from the head chips Hc5 and Hc7 having a large ejection weight, the ejection weight of the ink droplets ejected from the head chips Hc6 and Hc8 is relatively small although the influence of the negative pressure is received. Therefore, it is possible to suppress the occurrence of the density unevenness at the boundary portion between a portion at which printing was performed by the head chips Hc1 and Hc3 and a portion at which printing was performed by the head chip Hc6 and Hc8, in the medium S.

In the present modification example, the X-axis direction corresponds to a “first direction” and the Y-axis direction corresponds to a “second direction”. In the present modification example, the head chips Hc1 and Hc3, or Hc6 and Hc8 correspond to the “first head chip”, and the head chips Hc2 and Hc4 or Hc5 and Hc7 correspond to the “second head chip”. Further, in the present modification example, the head chip Hc1 or the head chip Hc8 corresponds to the “first head chip B”, and the head chip Hc3 or the head chip Hc6 corresponds to the “first head chip A”. Further, in the present modification example, the head chip Hc2 or the head chip Hc7 corresponds to the “second head chip A”, and the head chip Hc4 or the head chip Hc5 corresponds to the “second head chip B”.

In the present modification example described above, the liquid ejecting head H1 corresponds to a “first liquid ejecting head” and the liquid ejecting head H2 corresponds to a “second liquid ejecting head”. Further, in the present embodiment, the Y-axis direction corresponds to the “main scanning direction”, and the +X direction corresponds to the “transport direction”.

Further, the position of each of the head chips Hc1 and Hc3 in the liquid ejecting head H1 in the X-axis direction corresponds to a “first position”, and the position of each of the head chips Hc2 and Hc4 in the X-axis direction corresponds to a “second position”. That is, each of the “first position” and the “second position” may be a single position or a plurality (two or more) of positions.

The head chip Hc5 of the liquid ejecting head H2 is located at the “first position” of the head chip Hc1 in the X-axis direction, and the head chip Hc7 is located at the “first position” of the head chip Hc3 in the X-axis direction. The head chip Hc6 is located at the “second position” of the head chip Hc2 in the X-axis direction, and the head chip Hc8 is located at the “second position” of the head chip Hc4 in the X-axis direction.

The liquid ejected by the head chips Hc1, Hc3, Hc6, and Hc8 corresponds to a “first liquid”, and the liquid ejected by the head chips Hc2, Hc4, Hc5, and Hc7 corresponds to a “second liquid”. The “first liquid” and the “second liquid” may be different liquids or may be the same liquid.

As described above, in the present modification example, it is possible to form small dots at the medium S by the head chips Hc1, Hc3, Hc6, and Hc8, and to improve the image quality. Further, since it is possible to form large dots at the medium S by the head chips Hc2, Hc4, Hc5, and Hc7, and to fill a wide area in a short time, it is possible to perform printing in a relatively short time, and to improve the productivity.

It is possible to perform printing that achieves both high productivity and high image quality, by ejecting ink droplets from the head chips Hc2, Hc4, Hc5, and Hc7 to a portion having a relatively wide area to be filled and ejecting ink droplets from the head chips Hc1, Hc3, Hc6, and Hc8 to a portion requiring high image quality in an image formed on one medium S.

In the present modification example, nozzle rows 22 in two adjacent head chips Hc in the X-axis direction among the head chips Hc1, Hc3, Hc6, and Hc8 can be partially overlapped in the X-axis direction to form the row of nozzles 21 that is continuous in the X-axis direction. Therefore, it is possible to reduce the number of times of causing the liquid ejecting head H to reciprocate in the Y-axis direction and to perform printing in a relatively short time. The same applies to the head chips Hc2, Hc4, Hc5, and Hc7.

Further, by providing the head chip Hc having a different ejection ability in one liquid ejecting head H, even when one liquid ejecting head H of the liquid ejecting heads H1 and H2 failed, both types of printing, that is, printing with high productivity and printing with high image quality may be performed although the reciprocating movement in the Y-axis direction is increased.

### Sixth Modification Example

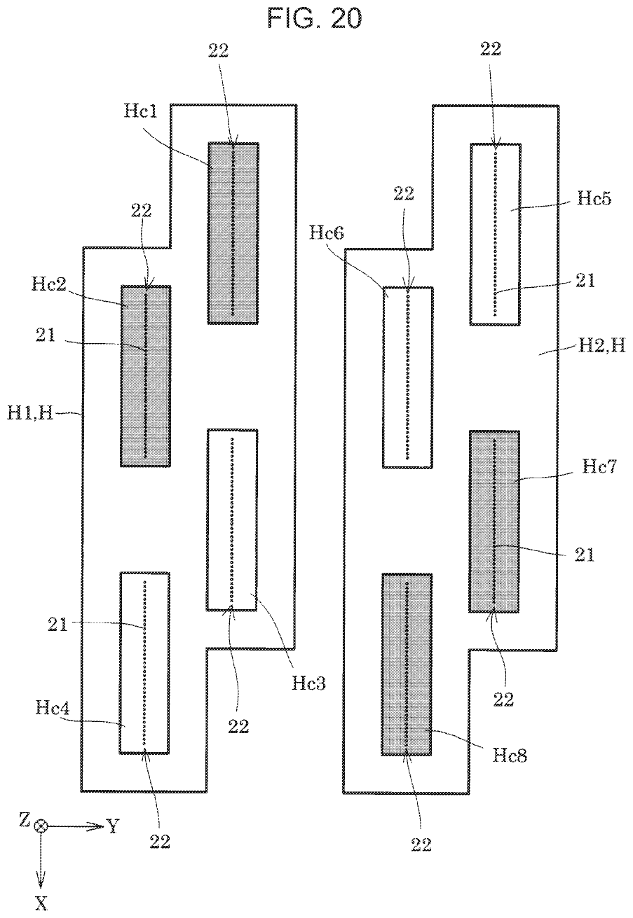

FIG. 20 is a schematic view of two liquid ejecting heads H provided in a liquid ejecting apparatus 1 in a sixth modification example of the first embodiment when viewed in the +Z direction. The present modification example is different from Modification Example 5 in the disposition of the head chips Hc having different ejection abilities.

In a liquid ejecting head H1, head chips Hc3 and Hc4 have a higher ejection ability than head chips Hc1 and Hc2. In a liquid ejecting head H2, head chips Hc5 and Hc6 have a higher ejection ability than head chips Hc7 and Hc8. The head chips Hc3, Hc4, Hc5, and Hc6 have substantially the same ejection ability, and the head chips Hc1, Hc2, Hc7, and Hc8 have substantially the same ejection ability.

Each head chips Hc has one nozzle row 22. The same ink is ejected from the respective nozzle rows 22 of the head chips Hc1 to Hc4 in the liquid ejecting head H1 and the head chips Hc5 to Hc8 in the liquid ejecting head H2. The ink ejected from the head chips Hc1, Hc2, Hc7, and Hc8 may be different from the ink ejected from the head chips Hc3, Hc4, Hc5, and Hc6. Each head chip Hc may have two nozzle rows.

In the present modification example described above, the position of each of the head chips Hc1 and Hc2 in the liquid ejecting head H1, which is an example of the “first liquid ejecting head”, in the X-axis direction corresponds to the “first position”, and the position of each of the head chips Hc3 and Hc4 in the X-axis direction corresponds to the “second position”. That is, each of the “first position” and the “second position” may be a single position or a plurality (two or more) of positions.

The head chip Hc5 of the liquid ejecting head H2, which is an example of the “second liquid ejecting head”, is located at the “first position” of the head chip Hc1 in the X-axis direction, and the head chip Hc6 is located at the “first position” of the head chip Hc2 in the X-axis direction. The head chip Hc7 is located at the “second position” of the head chip Hc3 in the X-axis direction, and the head chip Hc8 is located at the “second position” of the head chip Hc4 in the X-axis direction.

The liquid ejected by the head chips Hc1, Hc2, Hc7, and Hc8 corresponds to the “first liquid”, and the liquid ejected by the head chips Hc3 to Hc6 corresponds to the “second liquid”. The “first liquid” and the “second liquid” may be different liquids or may be the same liquid.

It is possible to form small dots at the medium S by the head chips Hc1, Hc2, Hc7, and Hc8, and to improve the image quality. Further, since it is possible to form large dots at the medium S by the head chips Hc3, Hc4, Hc5, and Hc6, and to fill a wide area in a short time, it is possible to perform printing in a relatively short time, and to improve the productivity.

It is possible to perform printing that achieves both high productivity and high image quality, by ejecting ink droplets from the head chips Hc3, Hc4, Hc5, and Hc6 to a portion having a relatively wide area to be filled and ejecting ink droplets from the head chips Hc1, Hc2, Hc7, and Hc8 to a portion requiring high image quality in an image formed on one medium S.

In the present modification example, nozzle rows 22 in two adjacent head chips Hc in the X-axis direction among the head chips Hc1, Hc2, Hc7, and Hc8 can be partially overlapped in the X-axis direction to form the row of nozzles 21 that is continuous in the X-axis direction. Therefore, it is possible to reduce the number of times of causing the liquid ejecting head H to reciprocate in the Y-axis direction and to perform printing in a relatively short time. The same applies to the head chips Hc3 to Hc6.

Further, by providing the head chip Hc having a different ejection ability in one liquid ejecting head H, even when one liquid ejecting head H of the liquid ejecting heads H1 and H2 failed, both types of printing, that is, printing with high productivity and printing with high image quality may be performed although the reciprocating movement in the Y-axis direction is increased.

### Second Embodiment

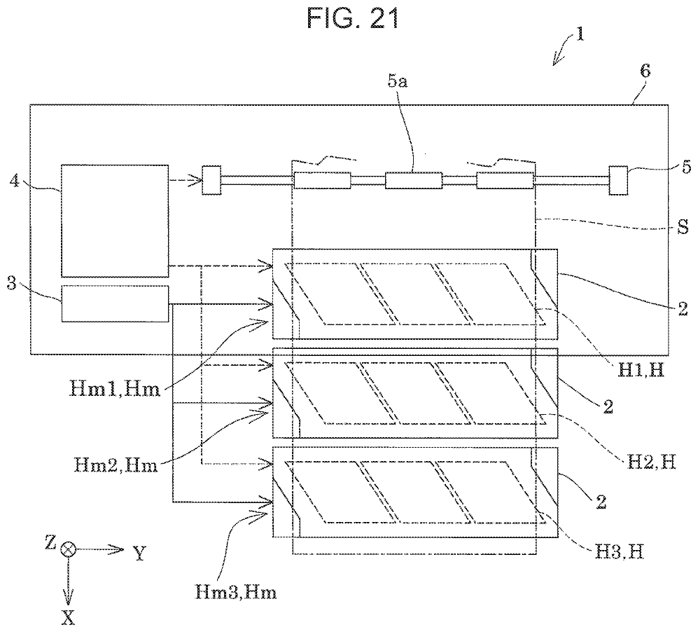

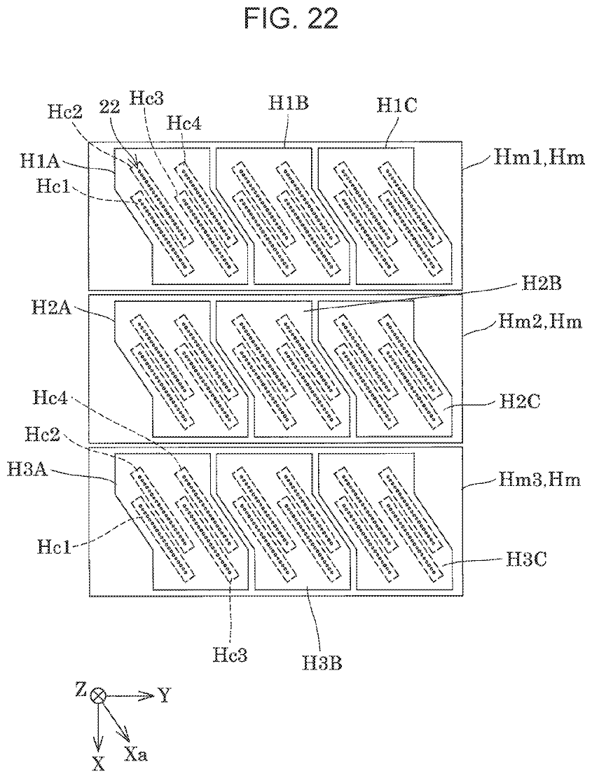

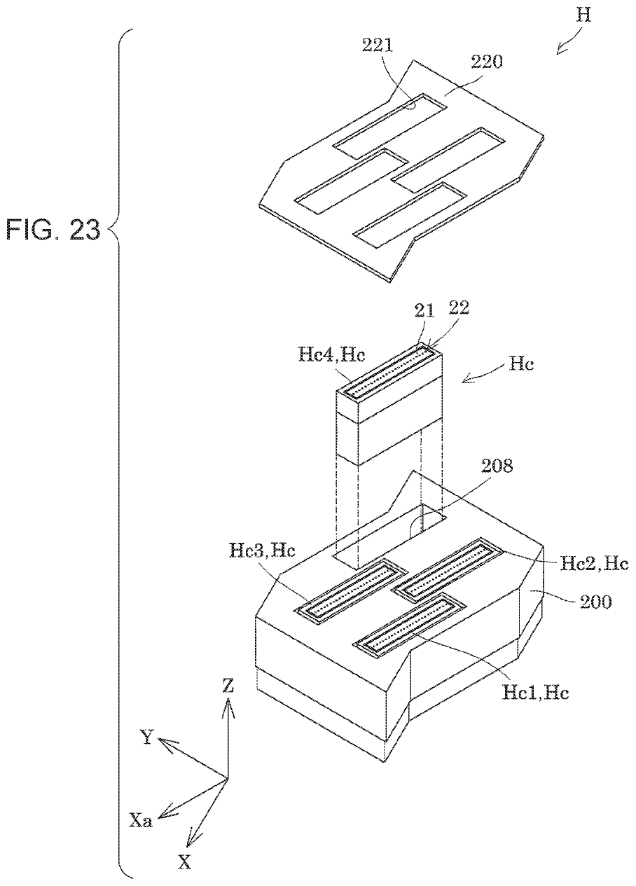

FIG. 21 is a view illustrating a schematic configuration of a liquid ejecting apparatus 1 according to a second embodiment of the present disclosure. FIG. 22 is a schematic view of a head module Hm when viewed in the +Z direction. The same reference signs will be given to the same members as those in the above-described embodiment, and overlapping description thereof will be omitted.

The liquid ejecting apparatus 1 illustrated in FIG. 21 is a so-called line printer that includes a plurality of head modules Hm including a plurality of liquid ejecting heads H, and performs printing by transporting a medium S in the X-axis direction and ejecting an ink that is one type of “liquid” to the medium S from the liquid ejecting head H in the +Z direction.

The head module Hm has a shape in which the Y-axis direction is set to a longitudinal direction and the X-axis direction is set to a lateral direction when viewed in the Z-axis direction. The head module Hm includes a plurality of liquid ejecting heads H and a support 2 that supports the plurality of liquid ejecting heads H. In the present embodiment, one head module Hm includes three liquid ejecting heads H. The three liquid ejecting heads H are arranged side by side in the Y-axis direction to have the same position in the X-axis direction.

Three head modules Hm described above are provided in the present embodiment. The three head modules Hm are arranged side by side in the X-axis direction to be located at the same position in the Y-axis direction. In the present embodiment, the three head modules Hm are sequentially referred to as a head module Hm1, a head module Hm2, and a head module Hm3 in the +X direction. When the head modules Hm1 to Hm3 are not distinguished from each other, the head modules Hm1 to Hm3 are referred to as the head module Hm.

Each head module Hm is disposed such that a plurality of nozzles 21 are distributed over the entire range of the medium S in the Y-axis direction. The support 2 is fixed to a housing (not illustrated) of the liquid ejecting apparatus 1. Therefore, the head module Hm does not move in the Y-axis direction regarding the time of printing.

However, the head module Hm may move in the Y-axis direction or the X-axis direction regarding the time of the maintenance of the liquid ejecting head H.

Each head module Hm includes three liquid ejecting heads H. In the present embodiment, the three liquid ejecting heads H of the head module Hm1 are referred to as liquid ejecting heads H1, and the three liquid ejecting heads H1 are sequentially referred to as a liquid ejecting head H1A, a liquid ejecting head H1B, and a liquid ejecting head H1C in the +Y direction.

Further, the three liquid ejecting heads H of the head module Hm2 are referred to as liquid ejecting heads H2, and the liquid ejecting heads H2 are sequentially referred to as a liquid ejecting head H2A, a liquid ejecting head H2B, and a liquid ejecting head H2C in the +Y direction. Further, the three liquid ejecting heads H of the head module Hm3 are referred to as liquid ejecting heads H3, and the liquid ejecting heads H3 are sequentially referred to as a liquid ejecting head H3A, a liquid ejecting head H3B, and a liquid ejecting head H3C in the +Y direction. When the liquid ejecting heads H1 to H3 are not distinguished from each other, the liquid ejecting heads H1 to H3 are referred to as the liquid ejecting head H below.

The liquid ejecting apparatus 1 includes the liquid storage section 3, the control unit 4, and the transport mechanism 5, which are similar to those in the first embodiment described above. Since the liquid storage section 3, the control unit 4, and the transport mechanism 5 are similar to those in the first embodiment described above, the repetitive description thereof will be omitted.

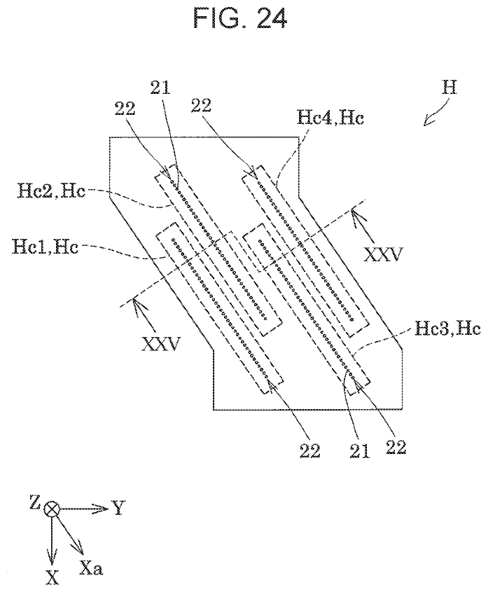

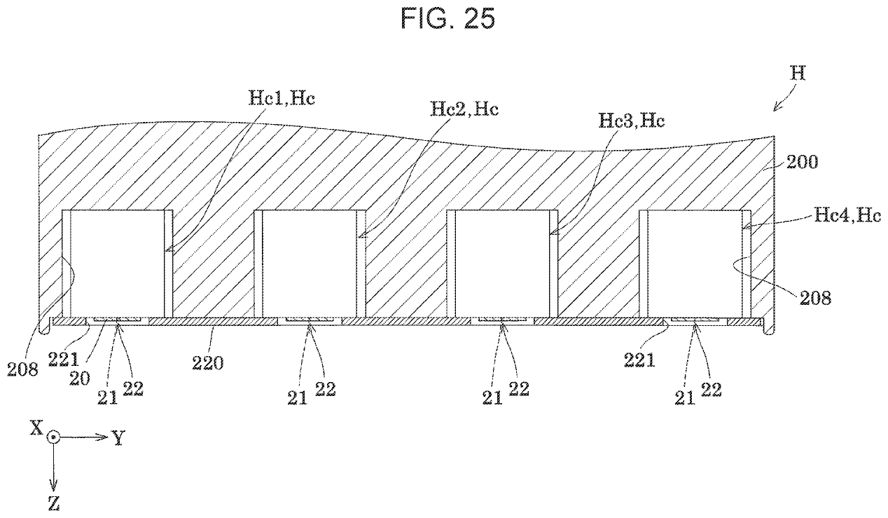

An example of the liquid ejecting head H will be further described with reference to FIGS. 23 to 25. FIG. 23 is an exploded perspective view of the liquid ejecting head H when viewed in the −Z direction. FIG. 24 is a schematic view of the liquid ejecting head H when viewed in the +Z direction. FIG. 25 is a cross-sectional view taken along the line XXV-XXV of FIG. 24.

As illustrated in FIG. 23, the liquid ejecting head H includes a plurality of head chips Hc, a flow path member 200 to which the plurality of head chips Hc are fixed in common, and a cover head 220.

The liquid ejecting head H includes four head chips Hc. In the present embodiment, the head chip Hc has one nozzle row 22 in which nozzles 21 are arranged side by side. Since the basic configuration of the head chip Hc is similar to that in the first embodiment described above, the repetitive description thereof will be omitted. The head chip Hc may have two nozzle rows 22.

Such a head chip Hc is fixed to the flow path member 200. A flow path 400 similar to that in the above-described embodiment is provided inside (not illustrated) the flow path member 200. By branching the flow path 400 in the middle, the flow path 400 commonly communicates with the head chips Hc provided at the same position in the X-axis direction. That is, different inks are supplied to the head chips Hc provided at different positions of one liquid ejecting head H in the X-axis direction.

In addition, the flow path member 200 is provided with an accommodation portion 208 for accommodating the head chip Hc. The accommodation portion 208 may be able to individually accommodate each head chip Hc, or may accommodate a plurality of head chips Hc in common. The cover head 220 is provided on the surface of the flow path member 200 facing the +Z direction in which the accommodation portion 208 is open. Since the cover head 220 is similar to that in the first embodiment described above, the repetitive description thereof will be omitted.

The head chip Hc is held in the flow path member 200 such that a direction in which the nozzles 21 are arranged side by side is set as an Xa direction inclined with respect to both the X-axis direction and the Y-axis direction. Four head chips Hc are arranged side by side in a staggered manner along the Y-axis direction. In other words, regarding the four head chips Hc, two rows are disposed in the X-axis direction, Each of the rows is configured by two head chips Hc arranged side by side in the Y-axis direction to have the same position in the X-axis direction. In the present embodiment, the four head chips Hc are sequentially referred to as a head chip Hc1, a head chip Hc2, a head chip Hc3, and a head chip Hc4 in the +Y direction. When the head chips Hc1 to Hc4 are not distinguished from each other, the head chips Hc1 to Hc4 are referred to as the head chip Hc.

The nozzle row 22 of the head chip Hc1 and the nozzle row 22 of the head chip Hc3 are disposed to partially overlap each other when viewed in the X-axis direction. Further, the nozzle row 22 of the head chip Hc2 and the nozzle row 22 of the head chip Hc4 are disposed to partially overlap each other when viewed in the X-axis direction. Therefore, the nozzle rows 22 of the two head chips Hc can be partially overlapped when viewed in the X-axis direction to form a row of the nozzles 21 that is continuous in the Y-axis direction.

The respective nozzles 21 in the head chip Hc1 and the head chip Hc2 are disposed at the same position in the Y-axis direction, and the respective nozzles 21 in the head chip Hc3 and the head chip Hc4 are disposed at the same position in the Y-axis direction.

The liquid ejecting head H has a shape in which a portion of both sides of the liquid ejecting head H in the Y-axis direction, the sides defining an outer shape, is along the Xa direction when viewed in the Z-axis direction. Therefore, when the liquid ejecting heads H are arranged in the Y-axis direction as illustrated in FIG. 25, the nozzle row 22 of the head chip Hc4 in one liquid ejecting head H and the nozzle row 22 of the head chip Hc2 in the other liquid ejecting head H can be partially overlapped when viewed in the X-axis direction, and thus a row of the nozzles 21 that is continuous in the Y-axis direction can be formed. Similarly, the nozzle row 22 of the head chip Hc3 in one liquid ejecting head H and the nozzle row 22 of the head chip Hc1 in the other liquid ejecting head H can be partially overlapped when viewed in the X-axis direction, and thus a row of the nozzles 21 that is continuous in the Y-axis direction can be formed.

The head chips Hc2 and Hc4 of the liquid ejecting head H1 in the head module Hm1 have a higher ejection ability than the head chips Hc1 and Hc3. The head chip Hc1 and the head chip Hc3 have substantially the same ejection ability, and the head chip Hc2 and the head chip Hc4 have substantially the same ejection ability.

The four head chips Hc of the liquid ejecting head H2 in the head module Hm2 have substantially the same ejection ability. Further, the four head chips Hc of the liquid ejecting head H2 have substantially the same ejection ability as the head chips Hc1 and Hc3 of the liquid ejecting head H1.

The head chips Hc1 and Hc3 of the liquid ejecting head H3 in the head module Hm3 have a higher ejection ability than the head chips Hc2 and Hc4. The head chip Hc1 and the head chip Hc3 have substantially the same ejection ability, and the head chip Hc2 and the head chip Hc4 have substantially the same ejection ability. Further, the head chip Hc2 and the head chip Hc4 of the liquid ejecting head H3 have substantially the same ejection ability as the four head chips Hc of the liquid ejecting head H2.

When the medium S is transported in the +X direction and printing is performed by using such three head modules Hm, the pre-treatment liquid is ejected from the head chips Hc2 and Hc4 of the liquid ejecting head H1 in the head module Hm1. Then, an image is printed in a manner that four types of inks containing coloring materials are respectively ejected onto the pre-treatment liquid from the head chips Hc1 and Hc3 of the liquid ejecting head H1, the liquid ejecting head H2 of the head module Hm2, and the head chips Hc2 and Hc4 of the liquid ejecting head H3 in the head module Hm3. Thereafter, the post-treatment liquid is ejected onto the image from the head chips Hc1 and Hc3 of the liquid ejecting head H3 in the head module Hm3. As a result, it is possible to improve the productivity and improve the image quality while following the order of ejecting the pre-treatment liquid, the ink containing the coloring material, and the post-treatment liquid.

When the above liquid ejecting head H is provided with only the head chip Hc having the same ejection ability, in order to achieve both high productivity and high image quality, it is necessary to provide four liquid ejecting heads in total in the X-axis direction, that is, a liquid ejecting head that ejects the pre-treatment liquid, two liquid ejecting heads that eject an ink containing the coloring material, and a liquid ejecting head that ejects the post-treatment liquid. That is, four head modules Hm are required. Compared to this, in the present modification example, by providing the head chips Hc having different ejection abilities in one liquid ejecting head H, the pre-treatment liquid, the ink containing the coloring material, and the post-treatment liquid can be sequentially ejected while following the order of the liquids to be ejected in the transport direction of the medium S by the three liquid ejecting heads H. Therefore, it is possible to reduce the number of the liquid ejecting heads H while achieving both high productivity and high image quality, and it is possible to reduce the space occupied by the liquid ejecting head H and to reduce the size of the liquid ejecting apparatus 1.

In addition, the liquid ejecting heads H in the first embodiment and the first to sixth modification examples described above can be used in the line-type liquid ejecting apparatus 1 in the present embodiment.

In the present embodiment, the head chips Hc1 and Hc3 of the liquid ejecting head H1 correspond to the “first head chip”, and the head chips Hc2 and Hc4 of the liquid ejecting head H1 correspond to the “second head chip”. Further, the head chips Hc1 and Hc3 of the liquid ejecting head H1 correspond to a “first chip group”, and the head chips Hc2 and Hc4 of the liquid ejecting head H1 correspond to a “second chip group”.

Further, in the present embodiment, the head chip Hc of the liquid ejecting head H2 corresponds to a “head chip having the same ejection ability as the first head chip”.

Further, in the present embodiment, the head chips Hc2 and Hc4 of the liquid ejecting head H3 correspond to the “first head chip”, and the head chips Hc1 and Hc3 of the liquid ejecting head H3 correspond to the “second head chip”. Further, the head chips Hc2 and Hc4 of the liquid ejecting head H3 correspond to the “first chip group”, and the head chips Hc1 and Hc3 of the liquid ejecting head H3 correspond to the “second chip group”.

In addition, in the present embodiment, the Y-axis direction corresponds to the “first direction”, and the X-axis direction corresponds to the “second direction”. Further, in the present embodiment, the transport mechanism 5 corresponds to a “transport unit”, and the +Y direction corresponds to the “transport direction”.

Further, in the present embodiment, the head module Hm1 corresponds to a “first line head”, the head module Hm3 corresponds to a “second line head”, and the head module Hm2 corresponds to a “third line head”.

### OTHER EMBODIMENTS

Although each embodiment of the present disclosure was described above, the basic configuration of the present disclosure is not limited to the above description.

For example, in each of the embodiments and the modification examples described above, it is assumed that one liquid ejecting head H includes a plurality of “first head chips” and “second head chips”, respectively, but the present disclosure is not particularly limited to this. The liquid ejecting head may include at least one “first head chip” and at least one “second head chip”.

In addition, in each of the embodiments and the modification examples described above, the “driving element” that causes the pressure change in the pressure chamber 12 was described by using the thin-film type piezoelectric actuator 300. The present disclosure is not particularly limited thereto. As the “driving element”, for example, a thick-film type piezoelectric actuator formed by a method such as sticking a green sheet can be used. In addition, as the “driving element”, a longitudinal vibration type piezoelectric actuator in which a piezoelectric material and an electrode forming material are alternately stacked and expanded and contracted in an axial direction can be used. In addition, as the “driving element”, for example, an element in which a heat generating element is disposed in the pressure chamber to eject the droplets from the nozzle by bubbles generated due to the heat of the heat generating element, or a so-called electrostatic actuator that generates static electricity between a diaphragm and an electrode, deforms the diaphragm by the electrostatic force, and ejects the droplets from the nozzle can be used. The ejection weight when the heat generating element is used changes by not only the above-described flow path structure, but also, for example, the magnitude of the heat generation amount of the heat generating element and the like. Here, the heat generation amount of the heat generating element refers to the magnitude of the resistance value of a resistor which is the heat generating element. For example, when the resistance value of the resistor is large, the heat generation amount is large when the resistor is driven at the same voltage, and thus the ejection weight is large. When the resistance value of the resistor is small, the heat generation amount is small, and thus the ejection weight is small. Therefore, the head chip having the heat generating element having a small heat generation amount may be used as the “first head chip”, and the head chip having the heat generating element having a large heat generation amount may be used as the “second head chip”.

### Supplementary Notes

From the embodiments exemplified above, for example, the following configuration can be grasped.

According to Aspect 1 that is a preferred aspect, a liquid ejecting head includes a plurality of head chips that eject a liquid, in which the plurality of head chips include one or a plurality of first head chips and one or a plurality of second head chips having a higher ejection ability than the first head chip.

In Aspect 2 that is a specific example of Aspect 1, the plurality of head chips include a first chip group including a plurality of head chips that includes the first head chips and have the same ejection ability as the first head chips, and a second chip group including a plurality of head chips that includes the second head chips and have the same ejection ability as the second head chips, the plurality of head chips in the first chip group are arranged in a first direction, and adjacent head chips are disposed to partially overlap each other when viewed in a second direction perpendicular to the first direction, the plurality of head chips in the second chip group are arranged in the first direction, and adjacent head chips are disposed to partially overlap each other when viewed in the second direction, and the first chip group and the second chip group are disposed to deviate from each other in the second direction.

According to Aspect 3 that is a preferred aspect, a liquid ejecting apparatus including the liquid ejecting head described in Aspect 2, the apparatus includes a first line head that includes one or a plurality of the liquid ejecting heads and has the first direction as a longitudinal direction, and a transport unit that transports a medium in a transport direction, in which the first chip group in the liquid ejecting head of the first line head is disposed on a downstream of the second chip group in the transport direction, the first chip group in the liquid ejecting head of the first line head ejects an ink containing a coloring material, and the second chip group in the liquid ejecting head of the first line head ejects a pre-treatment liquid.

In Aspect 4 that is a specific example of Aspect 3, the liquid ejecting apparatus further includes a second line head that includes one or a plurality of the liquid ejecting heads and has the first direction as a longitudinal direction, in which the first line head is disposed on an upstream of the second line head in the transport direction, the first chip group in the liquid ejecting head of the second line head is disposed on an upstream of the second chip group in the transport direction, the first chip group in the liquid ejecting head of the second line head ejects an ink containing a coloring material, and the second chip group in the liquid ejecting head of the second line head ejects a post-treatment liquid.

In Aspect 5 that is a specific example of Aspect 4, the liquid ejecting apparatus further includes a third line head that is disposed between the first line head and the second line head in the transport direction, in which one or a plurality of liquid ejecting heads constituting the third line head include a plurality of head chips having the same ejection ability as the first head chip, and the plurality of head chips in the liquid ejecting head of the third line head eject an ink containing a coloring material.

In Aspect 6 that is a specific example of Aspect 1, the liquid ejecting head ejects a liquid while reciprocating in a main scanning direction, the plurality of head chips are arranged in the main scanning direction, the plurality of second head chips include a second head chip A disposed at one end of the main scanning direction and a second head chip B disposed at another end of the main scanning direction, the one or the plurality of first head chips are disposed between the second head chip A and the second head chip B, the one or the plurality of first head chips eject an ink containing a coloring material, the second head chip A ejects a pre-treatment liquid, and the second head chip B ejects a post-treatment liquid.

According to Aspect 7 that is a preferred aspect, a liquid ejecting apparatus including the liquid ejecting head described in Aspect 1, the apparatus includes a first liquid ejecting head that is the liquid ejecting head, a second liquid ejecting head that is the liquid ejecting head, and a carriage that holds the first liquid ejecting head and the second liquid ejecting head and reciprocates in a main scanning direction, in which the first liquid ejecting head and the second liquid ejecting head are arranged in the main scanning direction, the plurality of head chips of the first liquid ejecting head are arranged in the main scanning direction, the plurality of head chips of the second liquid ejecting head are arranged in the main scanning direction, the one or the plurality of first head chips in the first liquid ejecting head are disposed between the one or the plurality of second head chips in the first liquid ejecting head and the second liquid ejecting head in the main scanning direction, the one or the plurality of first head chips in the second liquid ejecting head are disposed between the one or the plurality of second head chips in the second liquid ejecting head and the first liquid ejecting head in the main scanning direction, the plurality of first head chips in the first liquid ejecting head and the second liquid ejecting head eject an ink containing a coloring material, the second head chip in the second liquid ejecting head ejects a pre-treatment liquid, and the second head chip in the first liquid ejecting head ejects a post-treatment liquid.

In Aspect 8 that is a specific example of Aspect 1, the liquid ejecting head ejects a liquid while reciprocating in a main scanning direction, the plurality of head chips are arranged in a transport direction of a medium perpendicular to the main scanning direction, the plurality of second head chips include a second head chip A disposed at one end of the transport direction and a second head chip B disposed at another end of the transport direction, the one or the plurality of first head chips are disposed between the second head chip A and the second head chip B, the one or the plurality of first head chips eject an ink containing a coloring material, the second head chip A ejects a pre-treatment liquid, and the second head chip B ejects a post-treatment liquid.

According to Aspect 9 that is a preferred aspect, a liquid ejecting apparatus includes the liquid ejecting head described in Aspect 1, and includes a first liquid ejecting head that is the liquid ejecting head, a second liquid ejecting head that is the liquid ejecting head, and a carriage that holds the first liquid ejecting head and the second liquid ejecting head and reciprocates in a main scanning direction, in which, in the first liquid ejecting head, the one or the plurality of second head chips are disposed on an upstream of the one or the plurality of first head chips in a transport direction of a medium, in the second liquid ejecting head, the one or the plurality of second head chips are disposed on a downstream of the one or the plurality of first head chips in the transport direction, the first liquid ejecting head and the second liquid ejecting head are disposed such that the one or the plurality of first head chips in the first liquid ejecting head have the same positions as the one or the plurality of first head chips in the second liquid ejecting head in the transport direction, the plurality of first head chips in the first liquid ejecting head and the second liquid ejecting head eject an ink containing a coloring material, the second head chip in the first liquid ejecting head ejects a pre-treatment liquid, and the second head chip in the second liquid ejecting head ejects a post-treatment liquid.

In Aspect 10 that is a specific example of Aspect 1, each of the plurality of head chips has a nozzle row in which a plurality of nozzles that eject a liquid are arranged in a first direction, the one or the plurality of first head chips include a first head chip A and a first head chip B that are disposed at the same positions in a second direction perpendicular to the first direction, and disposed at different positions in the first direction, the one or the plurality of second head chips include a second head chip A and a second head chip B that are disposed at the same positions in the second direction and disposed at different positions in the first direction, the first head chip A and the first head chip B are disposed at different positions from the second head chip A and the second head chip B in the second direction, when viewed in the second direction, one end portion of the nozzle row in the first head chip A partially overlaps the nozzle row in the second head chip A, another end portion of the nozzle row in the first head chip A partially overlaps one end portion of the nozzle row in the second head chip B, and another end portion of the nozzle row in the second head chip A partially overlaps the nozzle row in the first head chip B, and an ink containing the same type of coloring material is supplied to the first head chip A, the first head chip B, the second head chip A, and the second head chip B via a common supply flow path.

In Aspect 11 that is a specific example of Aspect 1, the first head chip is compatible with the second head chip.

In Aspect 12 that is a specific example of Aspect 1, the liquid ejecting head includes a first accommodation space that accommodates the first head chip and a second accommodation space that accommodates the second head chip, the first head chip is configured to be accommodated in the second accommodation space, and the second head chip is configured to be accommodated in the first accommodation space.

In Aspect 13 that is a specific example of Aspect 1, when the same type of liquid is ejected by supplying the same drive waveform to the first head chip and the second head chip, a weight of a liquid ejected from a nozzle of the second head chip is more than a weight of a liquid ejected from a nozzle of the first head chip.

In Aspect 14 that is a specific example of Aspect 1, in one recording cycle, a maximum ejection weight when one dot is formed at a medium by ejecting a liquid from one nozzle of the second head chip is more than a maximum ejection weight when one dot is formed at the medium by ejecting a liquid from one nozzle of the first head chip.

According to Aspect 15 that is a preferred aspect, a liquid ejecting apparatus includes the liquid ejecting head described in Aspect 1, and includes a first liquid ejecting head that is the liquid ejecting head, a second liquid ejecting head that is the liquid ejecting head, and a carriage that holds the first liquid ejecting head and the second liquid ejecting head and reciprocates in a main scanning direction, in which the first liquid ejecting head and the second liquid ejecting head are disposed at the same position in a transport direction of a medium and are arranged in the main scanning direction, the one or the plurality of first head chips in the first liquid ejecting head are located at a first position in the transport direction, and the one or the plurality of second head chips in the first liquid ejecting head are located at a second position different from the first position in the transport direction, the one or the plurality of first head chips in the second liquid ejecting head are located at the second position in the transport direction, and the one or the plurality of second head chips in the second liquid ejecting head are located at the first position in the transport direction, the plurality of first head chips in the first liquid ejecting head and the second liquid ejecting head eject a first liquid, and the plurality of second head chips in the first liquid ejecting head and the second liquid ejecting head eject a second liquid.

What is claimed is:

1. A liquid ejecting head comprising:
a plurality of head chips configured to eject a liquid, the head chips including one or a plurality of first head chips and one or a plurality of second head chips having a higher ejection ability than the first head chips.

2. The liquid ejecting head according to claim 1, wherein
the plurality of head chips include
a first chip group including a plurality of head chips that includes the first head chips and have the same ejection ability as the first head chips, and
a second chip group including a plurality of head chips that includes the second head chips and have the same ejection ability as the second head chips,
the plurality of head chips in the first chip group are arranged in a first direction, and adjacent head chips are disposed to partially overlap each other when viewed in a second direction perpendicular to the first direction,
the plurality of head chips in the second chip group are arranged in the first direction, and adjacent head chips are disposed to partially overlap each other when viewed in the second direction, and
the first chip group and the second chip group are disposed to deviate from each other in the second direction.

3. A liquid ejecting apparatus including the liquid ejecting head according to claim 2, the apparatus comprising:
a first line head that includes one or a plurality of the liquid ejecting heads and has the first direction as a longitudinal direction; and
a transport unit that transports a medium in a transport direction, wherein
the first chip group in the liquid ejecting head of the first line head is disposed on a downstream of the second chip group in the transport direction,
the first chip group in the liquid ejecting head of the first line head ejects an ink containing a coloring material, and
the second chip group in the liquid ejecting head of the first line head ejects a pre-treatment liquid.

4. The liquid ejecting apparatus according to claim 3, further comprising:
a second line head that includes one or a plurality of the liquid ejecting heads and has the first direction as a longitudinal direction, wherein
the first line head is disposed on an upstream of the second line head in the transport direction,
the first chip group in the liquid ejecting head of the second line head is disposed on an upstream of the second chip group in the transport direction,
the first chip group in the liquid ejecting head of the second line head ejects an ink containing a coloring material, and
the second chip group in the liquid ejecting head of the second line head ejects a post-treatment liquid.

5. The liquid ejecting apparatus according to claim 4, further comprising:
a third line head that is disposed between the first line head and the second line head in the transport direction, wherein
one or a plurality of liquid ejecting heads constituting the third line head include a plurality of head chips having the same ejection ability as the first head chip, and
the plurality of head chips in the liquid ejecting head of the third line head eject an ink containing a coloring material.

6. The liquid ejecting head according to claim 1, wherein
the liquid ejecting head is configured to eject a liquid while reciprocating in a main scanning direction,
the plurality of head chips are arranged in the main scanning direction,
the plurality of second head chips include a second head chip A disposed at one end of the main scanning direction and a second head chip B disposed at another end of the main scanning direction,
the one or the plurality of first head chips are disposed between the second head chip A and the second head chip B,
the one or the plurality of first head chips eject an ink containing a coloring material,
the second head chip A ejects a pre-treatment liquid, and
the second head chip B ejects a post-treatment liquid.

7. A liquid ejecting apparatus including the liquid ejecting head according to claim 1, the apparatus comprising:
a first liquid ejecting head that is the liquid ejecting head;
a second liquid ejecting head that is the liquid ejecting head; and
a carriage that holds the first liquid ejecting head and the second liquid ejecting head and reciprocates in a main scanning direction, wherein
the first liquid ejecting head and the second liquid ejecting head are arranged in the main scanning direction,
the plurality of head chips of the first liquid ejecting head are arranged in the main scanning direction,
the plurality of head chips of the second liquid ejecting head are arranged in the main scanning direction,
the one or the plurality of first head chips in the first liquid ejecting head are disposed between the one or the plurality of second head chips in the first liquid ejecting head and the second liquid ejecting head in the main scanning direction,
the one or the plurality of first head chips in the second liquid ejecting head are disposed between the one or the plurality of second head chips in the second liquid ejecting head and the first liquid ejecting head in the main scanning direction,
the plurality of first head chips in the first liquid ejecting head and the second liquid ejecting head eject an ink containing a coloring material,
the second head chip in the second liquid ejecting head ejects a pre-treatment liquid, and
the second head chip in the first liquid ejecting head ejects a post-treatment liquid.

8. The liquid ejecting head according to claim 1, wherein
the liquid ejecting head ejects a liquid while reciprocating in a main scanning direction,
the plurality of head chips are arranged in a transport direction of a medium perpendicular to the main scanning direction,
the plurality of second head chips include a second head chip A disposed at one end of the transport direction and a second head chip B disposed at another end of the transport direction,
the one or the plurality of first head chips are disposed between the second head chip A and the second head chip B,
the one or the plurality of first head chips eject an ink containing a coloring material,
the second head chip A ejects a pre-treatment liquid, and
the second head chip B ejects a post-treatment liquid.

9. A liquid ejecting apparatus including the liquid ejecting head according to claim 1, the apparatus comprising:
a first liquid ejecting head that is the liquid ejecting head;
a second liquid ejecting head that is the liquid ejecting head; and
a carriage that holds the first liquid ejecting head and the second liquid ejecting head and reciprocates in a main scanning direction, wherein
in the first liquid ejecting head, the one or the plurality of second head chips are disposed on an upstream of the one or the plurality of first head chips in a transport direction of a medium,
in the second liquid ejecting head, the one or the plurality of second head chips are disposed on a downstream of the one or the plurality of first head chips in the transport direction,
the first liquid ejecting head and the second liquid ejecting head are disposed such that the one or the plurality of first head chips in the first liquid ejecting head have the same positions as the one or the plurality of first head chips in the second liquid ejecting head in the transport direction,
the plurality of first head chips in the first liquid ejecting head and the second liquid ejecting head eject an ink containing a coloring material,
the second head chip in the first liquid ejecting head ejects a pre-treatment liquid, and
the second head chip in the second liquid ejecting head ejects a post-treatment liquid.

10. The liquid ejecting head according to claim 1, wherein
each of the plurality of head chips has a nozzle row in which a plurality of nozzles that eject a liquid are arranged in a first direction,
the one or the plurality of first head chips include a first head chip A and a first head chip B that are disposed at the same positions in a second direction perpendicular to the first direction, and disposed at different positions in the first direction,
the one or the plurality of second head chips include a second head chip A and a second head chip B that are disposed at the same positions in the second direction and disposed at different positions in the first direction, the first head chip A and the first head chip B are disposed at different positions from the second head chip A and the second head chip B in the second direction,
when viewed in the second direction,
one end portion of the nozzle row in the first head chip A partially overlaps the nozzle row in the second head chip A,
another end portion of the nozzle row in the first head chip A partially overlaps one end portion of the nozzle row in the second head chip B, and
another end portion of the nozzle row in the second head chip A partially overlaps the nozzle row in the first head chip B, and
an ink containing the same type of coloring material is supplied to the first head chip A, the first head chip B, the second head chip A, and the second head chip B via a common supply flow path.

11. The liquid ejecting head according to claim 1, wherein
the first head chip is compatible with the second head chip.

12. The liquid ejecting head according to claim 1, wherein
the liquid ejecting head includes a first accommodation space that accommodates the first head chip and a second accommodation space that accommodates the second head chip,
the first head chip is configured to be accommodated in the second accommodation space, and
the second head chip is configured to be accommodated in the first accommodation space.

13. The liquid ejecting head according to claim 1, wherein
when the same type of liquid is ejected by supplying the same drive waveform to the first head chip and the second head chip, a weight of a liquid ejected from a nozzle of the second head chip is more than a weight of a liquid ejected from a nozzle of the first head chip.

14. The liquid ejecting head according to claim 1, wherein
in one recording cycle, a maximum ejection weight when one dot is formed at a medium by ejecting a liquid from one nozzle of the second head chip is more than a maximum ejection weight when one dot is formed at the medium by ejecting a liquid from one nozzle of the first head chip.

15. A liquid ejecting apparatus including the liquid ejecting head according to claim 1, the apparatus comprising:
a first liquid ejecting head that is the liquid ejecting head;
a second liquid ejecting head that is the liquid ejecting head; and
a carriage that holds the first liquid ejecting head and the second liquid ejecting head and reciprocates in a main scanning direction, wherein
the first liquid ejecting head and the second liquid ejecting head are disposed at the same position in a transport direction of a medium and are arranged in the main scanning direction,
the one or the plurality of first head chips in the first liquid ejecting head are located at a first position in the transport direction,
the one or the plurality of second head chips in the first liquid ejecting head are located at a second position different from the first position in the transport direction,
the one or the plurality of first head chips in the second liquid ejecting head are located at the second position in the transport direction,
the one or the plurality of second head chips in the second liquid ejecting head are located at the first position in the transport direction,
the plurality of first head chips in the first liquid ejecting head and the second liquid ejecting head eject a first liquid, and
the plurality of second head chips in the first liquid ejecting head and the second liquid ejecting head eject a second liquid.
